(19) United States
(12) Patent Application Publication
(10) Pub. No.: US 2008/0238990 A1
(43) Pub. Date: Oct. 2, 2008

(54) CLEANING APPARATUS AND LIQUID EJECTION APPARATUS AND LIQUID EJECTION SURFACE CLEANING METHOD

(76) Inventor: Hiroshi INOUE, Kanagawa-ken (JP)

Correspondence Address: BIRCH STEWART KOLASCH & BIRCH, PO BOX 747, FALLS CHURCH, VA, 22040-0747, US

(21) Appl. No.: 12/057,228

(22) Filed: Mar. 27, 2008

(30) Foreign Application Priority Data
Mar. 30, 2007 (JP) 2007-095514

(51) Int. Cl. B41J 2/165

(52) U.S. Cl. 347/33

(57) ABSTRACT

A cleaning apparatus which cleans a liquid ejection surface of a liquid ejection head, has: a liquid storage chamber which stores a first liquid; a vibrating device which converts the first liquid stored in the liquid storage chamber into fine particles of the first liquid; a fine liquid particle outlet port from which the fine particles of the first liquid is sprayed toward the liquid ejection surface; and a wiping device which wipes the liquid ejection surface after the fine particles of the first liquid sprayed from the fine liquid particle outlet port are deposited on the liquid ejection surface.

### BACKGROUND OF THE INVENTION

1. Field of the Invention

The present invention relates to a cleaning apparatus, a liquid ejection apparatus and a liquid ejection surface cleaning method, and more particularly, to technology for maintaining the liquid ejection surface of a liquid ejection head.

2. Description of the Related Art

In general, an inkjet recording apparatus which forms a desired image by ejecting ink droplets from an inkjet head onto a recording medium is widely used as a generic image forming apparatus. In such an inkjet recording apparatus, ink is liable to adhere to the ink ejection surface (nozzle surface) of the inkjet head, and if residual ink of this kind solidifies, then it can cause ejection abnormalities, such as abnormalities in the ink ejection volume or abnormalities in the ejection direction. Consequently, it is necessary to carry out periodic maintenance (cleaning) of the ink ejection surface of the inkjet head.

One method for cleaning an ink ejection surface is a method which wipes the ink ejection surface by means of a wiping member, such as a blade, after wetting the ink ejection solidified. More specifically, the solidified ink adhering to the ink ejection surface is removed as follows: the ink ejection surface is sealed with a cap, the interior of the cap is set to reduced pressure by means of a pump, the ink inside the inkjet head is drawn out from the nozzles and into the cap, the ink ejection surface is wetted by using the ink which has been drawn out from the nozzles, solidified ink adhering to the ink ejection surface is thereby dissolved, and then the ink ejection surface is wiped with the blade.

Another method is, for example, a wet type of method which wets the ink ejection surface using a cleaning liquid. Japanese Patent Application Publication No. 2005-161870 discloses a method for wiping the ink ejection surface with a cleaning roller impregnated with a cleaning liquid. Furthermore, Japanese Patent Application Publication No. 2006-289809 discloses an inkjet printer which adds a nozzle surface cleaning function to the cap. Moreover, Japanese Patent Application Publication No. 2005-28758 discloses a method which causes a cleaning liquid pressurized by a pressurization pump to vibrate ultrasonically by means of an ultrasonic vibrating element, and to spray out into the interior of the nozzles from cleaning liquid nozzles, whereby the interior of the nozzles is cleaned by means of the synergic effect of the pressure of the spraying action and the acceleration of the ultrasonic vibration.

However, in the invention described in Japanese Patent Application Publication No. 2005-161870, since the cleaning roller which has an impregnating capability makes contact with the ink ejection surface, there is a concern that soiling may be transferred from the ink ejection surface to the cleaning roller. If the soiling which has been transferred to the cleaning roller is not removed, then the cleaning liquid may become soiled, or when the ink ejection surface is next wiped, the soiling on the cleaning roller may adhere to the ink ejection surface again.

In the invention described in Japanese Patent Application Publication No. 2006-289809, the meniscus inside the nozzles breaks down when the cleaning liquid is blown onto the nozzle surface, and therefore, unless the meniscus is restored for the next ink ejection operation, it is not possible to eject ink properly. Moreover, a large amount of cleaning liquid enters into the nozzles; therefore, even if flushing is carried out after wiping, it is difficult to completely remove the cleaning liquid from the interior of the nozzles by flushing, and there is a possibility that this will lead to decline in the print density.

In the invention described in Japanese Patent Application Publication No. 2005-28758, since the object is to clean the interior of the nozzles, then the meniscus inside the nozzles is broken down by the spraying of the cleaning liquid (due to the fact that the cleaning liquid is sprayed in the form of a continuous flow), and unless the meniscus is restored for the next ink ejection operation, it is not possible to eject ink properly.

### SUMMARY OF THE INVENTION

The present invention has been contrived in view of these circumstances, an object thereof being to provide a cleaning apparatus, a liquid ejection apparatus and a liquid ejection surface cleaning method whereby satisfactory maintenance of the liquid ejection surface can be achieved by moistening the liquid ejection surface, without causing breakdown of the meniscus in a nozzle.

One aspect of the present invention relates to a cleaning apparatus which cleans a liquid ejection surface of a liquid ejection head, the cleaning apparatus comprising: a liquid storage chamber which stores a first liquid; a vibrating device which converts the first liquid stored in the liquid storage chamber into fine particles of the first liquid; a fine liquid particle outlet port from which the fine particles of the first liquid is sprayed toward the liquid ejection surface; and a wiping device which wipes the liquid ejection surface after the fine particles of the first liquid sprayed from the fine liquid particle outlet port are deposited on the liquid ejection surface.

In this aspect of the invention, since the liquid ejection surface is wetted by fine liquid particles (droplets) sprayed from a nozzle, then the wiping of the liquid ejection surface by the wiping device is a wet wiping action, and the adhering material on the liquid ejection surface can be removed suitably, in addition to which damage to the lyophobic film (lyophobic treatment) on the liquid ejection surface is prevented.

The liquid which is formed into fine liquid particles may be, for example, droplets in the form of a mist having an average diameter of 3 μm, which are separated from the liquid surface by means of a vibrating action.

A desirable mode is one where a plurality of fine liquid particle outlet ports for spraying fine liquid particles are provided in a region corresponding to the whole of the liquid ejection surface.

There may be a mode where the wiping device comprises a wiping member, such as a blade that abuts against the liquid ejection surface, a movement mechanism which moves the wiping member, and a movement control device which controls the movement mechanism. Furthermore, to give one example of the movement mechanism, a carriage which supports the wiping member, a guide member which supports the carriage movably, and a motor (actuator) which forms a drive source for the carriage (blade), are provided.

A desirable mode for controlling the amount of fine liquid particles deposited onto the liquid ejection surface is a mode where the vibration pressure and the vibration frequency of the vibrating device are varied. More specifically, if the vibration pressure of the vibrating device is made relatively larger, then the amount of fine liquid particles deposited on the liquid ejection surface becomes relatively greater. Furthermore, if the vibration frequency is made relatively higher, then the size of the fine liquid particles becomes relatively smaller, and furthermore, the amount of fine liquid particles deposited on the liquid ejection surface becomes relatively smaller.

Desirably, the fine particles of the first liquid are sprayed from the fine liquid particle outlet port only by a vibration pressure caused by the vibrating device.

In this aspect of the invention, since the fine liquid particles are deposited on the liquid ejection surface only by means of the pressure for generating the fine liquid particles, then breakdown of the meniscus in an ejection port provided in the liquid ejection surface is prevented.

Desirably, the wiping device wipes the liquid ejection surface after a prescribed period of time has elapsed from when the fine particles of the first liquid are sprayed toward the liquid ejection surface.

In this aspect of the invention, since the liquid ejection surface is wiped after the fine liquid particles deposited on the liquid ejection surface have aggregated, then the solidified adhering material is dissolved by the liquid, the remaining adhering material is made to float up from the liquid ejection surface, and improved performance in removing the adhering material can be expected.

For example, there is a mode where a measuring device which measures the elapsed time from the start of spraying of the fine liquid particles is provided, in such a manner that the wiping device is operated after a prescribed period of time has elapsed from the start of spraying (namely, the time period required for the fine liquid particles deposited on the liquid ejection surface to aggregate).

Desirably, the cleaning apparatus further comprises a movement device which causes a relative movement between the liquid ejection surface and the fine liquid particle outlet port disposed so as to oppose the liquid ejection surface, over the whole liquid ejection surface.

In this aspect of the invention, it is possible to deposit fine liquid particles over the whole of the liquid ejection surface of the liquid ejection head (the ejection port plate where the ejection ports are provided, for example).

To give one example of the movement device, a carriage which supports a fine liquid particle generating device including the fine liquid particle outlet port and a liquid storage chamber, a guide member which guides the carriage movably, and a motor (actuator) which serves as a drive source for the carriage, are provided.

Furthermore, by causing the fine liquid particle outlet port to move within a plane parallel to the liquid ejection surface, it is possible to achieve a uniform distance (clearance) between the fine liquid particle outlet port and the liquid ejection surface, and it is possible to deposit the liquid which has been converted into fine liquid particles, uniformly, onto the liquid ejection surface.

Desirably, the vibrating device comprises a piezoelectric element.

In this aspect of the invention, it is possible to make the liquid inside the liquid storage chamber vibrate at high frequency by applying a high-frequency AC voltage to the piezoelectric element, and hence the liquid inside the liquid storage chamber is converted into fine liquid particles suitably.

A desirable mode is one which comprises a voltage application device which applies a high-frequency AC voltage to the piezoelectric element, and a high-frequency AC voltage control device which varies the voltage (amplitude) of the high-frequency AC voltage and the frequency of the high-frequency AC voltage.

Desirably, the first liquid is water.

This aspect of the invention is desirable from both the cost benefit viewpoint and the environmental viewpoint.

Desirably, the cleaning apparatus further comprises: a determination device which determines presence or absence of adhering material on the liquid ejection surface and a position of the adhering material on the liquid ejection surface; and a vibration control device which controls the vibrating device in such a manner that an amount of the fine particles of the first liquid to be deposited on the liquid ejection surface is made greater at a position where the presence of the adhering material has been determined by the determination device, than at a position where the presence of the adhering material has not been determined by the determination device.

In this aspect of the invention, since fine liquid particles are deposited in greater volume at a position where adhering material is present on the liquid ejection surface, than at a position where adhering material is not present, then the adhering material attached to the liquid ejection surface is dissolved (or made to float off) and improvement in the performance of removing adhering material can be expected.

A desirable mode is one where the determination device comprises an imaging element which captures an image of the liquid ejection surface, an image processing device which judges the presence or absence of adhering material by analyzing the image signal obtained from the imaging element, and a position determination device which determines the position of the adhering material from the position of the imaging element.

Desirably, the cleaning apparatus further comprises: a determination device which determines presence or absence of adhering material and a position of the adhering material with respect to each of regions into which the liquid ejection surface divided; a vibration control device which controls the vibrating device in such a manner that an amount of the fine particles of the first liquid to be deposited on the liquid ejection surface is made greater in a region where the presence of the adhering material has been determined by the determination device, than in a region where the presence of the adhering material has not been determined by the determination device.

In this aspect of the invention, since the amount of the liquid deposited is determined with respect to each of the areas into which the liquid ejection surface is divided, then the control of the amount of liquid deposited on the ejection surface is simplified and reduction in the control load for the whole apparatus can be expected.

One possible mode for setting a plurality of areas on the liquid ejection surface is a mode where the liquid ejection surface is divided up into a plurality of areas having equal surface area. Furthermore, in relation to a mode for depositing liquid over the whole surface of the liquid ejection surface while moving the fine liquid particle outlet port, a desirable mode is one where the liquid ejection surface is divided up following the direction of movement of the fine liquid particle outlet port.

Desirably, the determination device determines a thickness of the adhering material; and the vibration control device controls the vibrating device in such a manner that the amount of the fine particles of the first liquid to be deposited on the liquid ejection surface is increased, as the thickness of the adhering material determined by the determination device increases.

In this aspect of the invention, it is possible to judge the amount of adhering material accurately by determining the thickness of the adhering material, and hence the wetting amount is optimized according to the magnitude of the adhering material, and the adhering material which is attached to the liquid ejection surface can be wiped away and removed reliably. Furthermore, this also contributes to reducing wasteful consumption of the liquid used to wet the liquid ejection surface.

A desirable mode is one where the average thickness of the adhering material is determined, for determining the thickness of the adhering material. Furthermore, a desirable mode is one where the amount of liquid deposited on the liquid ejection surface is controlled so that the average thickness of the liquid is twice the thickness (average thickness) of the adhering material.

Desirably, the vibration control device controls the vibrating device in such a manner that the fine particles of the first liquid are deposited on the liquid ejection surface so that an average thickness of the first liquid on the liquid ejection surface is two times the thickness of the adhering material.

In this aspect of the invention, the wetting amount on the liquid ejection surface is optimized, and furthermore wasteful consumption of the liquid used to wet the liquid ejection surface is reduced.

Another aspect of the invention relates to a liquid ejection apparatus comprising: a liquid ejection head which ejects a second liquid onto an ejection receiving medium; and any one of the cleaning apparatuses described above.

One possible example of the liquid ejection apparatus is an inkjet recording apparatus which forms a desired image on a recording medium by ejecting colored inks onto the recording medium.

Another aspects of the invention relates to a liquid ejection surface cleaning method of cleaning a liquid ejection surface of a liquid ejection head, the liquid ejection surface cleaning method comprising the steps of: vibrate a first liquid so that fine particles of the first liquid are sprayed onto the liquid ejection surface; and wiping the liquid ejection surface after spraying the fine particles of the first liquid onto the liquid ejection surface.

According to the present invention, since a liquid ejection surface is wetted by fine liquid particles sprayed from a nozzle, then wiping of the liquid ejection surface by a wiping device is a wet wiping action, and adhering material on the liquid ejection surface can be removed satisfactorily, in addition to which damage to the lyophobic film (lyophobic treatment) on the liquid ejection surface is prevented.

### BRIEF DESCRIPTION OF THE DRAWINGS

The nature of this invention, as well as other objects and benefits thereof will be explained in the following with reference to the accompanying drawings, in which like reference characters designate the same or similar parts throughout the figures and wherein:

FIG. 1 is a perspective diagram showing a general composition of a cleaning apparatus relating to a first embodiment of the present invention;

FIG. 2 is a front view diagram of the cleaning apparatus shown in FIG. 1;

FIG. 3A is an oblique perspective view of a fine liquid particle generating apparatus, and FIG. 3B is a schematic view of the fine liquid particle generating apparatus;

FIG. 4 is a conceptual diagram showing the composition of a control system of the cleaning apparatus shown in FIG. 1;

FIG. 5 is a diagram for describing the relationship between the wetting amount and the adhering material removal performance;

FIG. 6 is a block diagram showing the composition of a cleaning apparatus relating to a second embodiment of the present invention;

FIG. 7A is a diagram showing the head in FIG. 6, as viewed from the liquid ejection surface;

FIG. 7B is a diagram showing one example of the division of areas in a head having nozzles arranged in a matrix configuration;

FIG. 7C is a schematic oblique perspective diagram of a fine liquid particle generating apparatus which corresponds to a divided area as shown in FIG. 7B;

FIG. 8 is a flowchart showing the sequence of control for maintenance by the cleaning apparatus shown in FIG. 6;

FIG. 9 is a general schematic drawing of an inkjet recording apparatus relating to an embodiment of the present invention;

FIG. 10 is a principal plan diagram of the peripheral area of a print unit in the inkjet recording apparatus illustrated in FIG. 9;

FIGS. 11A to 11C are plan view perspective diagrams showing examples of the composition of a print head;

FIG. 12 is a cross-sectional diagram along line XII-XII in FIGS. 11A and 11B;

FIG. 13 is a conceptual diagram showing the composition of an ink supply system of the inkjet recording apparatus shown in FIG. 9; and

FIG. 14 is a conceptual diagram showing the composition of a control system of the inkjet recording apparatus shown in FIG. 9.

### DETAILED DESCRIPTION OF THE PREFERRED EMBODIMENTS

### First Embodiment

### Composition of Cleaning Apparatus

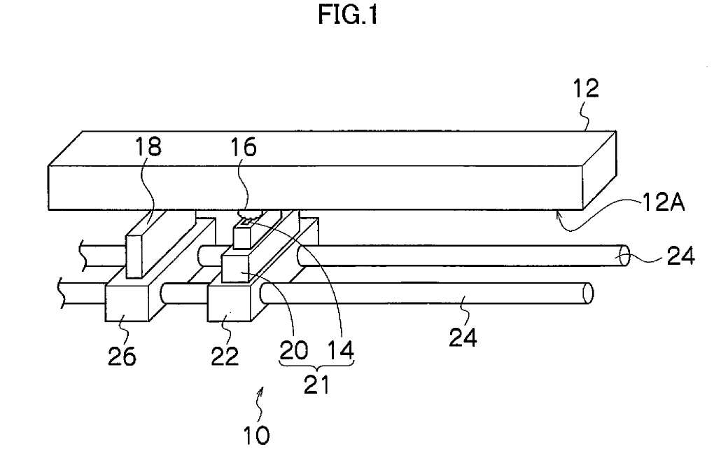

FIG. 1 is an oblique view showing the general composition of a cleaning apparatus 10 relating to an embodiment of the present invention. As shown in FIG. 1, the cleaning apparatus 10 is provided on the liquid ejection surface (nozzle surface) 12A side of a liquid ejection head (inkjet head) 12 (directly below the liquid ejection head), which is provided in a liquid ejection apparatus, such as an inkjet recording apparatus. The cleaning apparatus 10 sprays liquid in the form of fine liquid particles (fine liquid droplets) 16 having a diameter of approximately several μm from a fine liquid particle ejection port 14 (a nozzle), and after the fine liquid particles 16 have been deposited on and caused to aggregated on the liquid ejection surface (hereinafter, called the “ejection surface”) 12A of the liquid ejection head (hereinafter, called the “head”) 12, the ejection surface 12A which has been wetted by the fine liquid particles 16 is wiped with a blade 18, thereby removing the adhering material which has become attached to the ejection surface 12A. The fine liquid particles 16 shown in FIG. 1 are in aggregated state on the ejection surface 12A.

The cleaning apparatus 10 is composed so as to move between a maintenance position directly below the head 12 and a withdrawn position which is withdrawn from directly below the head 12. While liquid ejection is being performed by the head 12, the cleaning apparatus 10 is disposed in the withdrawn position, and when maintenance of the head 12 (the wiping of the ejection surface 12A) is being carried out, the cleaning apparatus 10 is disposed in the maintenance position directly below the head 12. FIG. 1 shows a state where the cleaning apparatus 10 is disposed in the maintenance position.

The adhering material which is attached to the ejection surface 12A may be solidified ink, liquid ink, paper dust, or other forms of dust, and if the ejection surface 12A is wiped with the blade 18 when the ejection surface 12A is in a dried state or an insufficiently wetted state (dry wiping), then not only is it difficult to remove the adhering material sufficiently, but there is also a possibility of causing damage to the lyophobic film formed on the ejection surface 12A.

On the other hand, in the present embodiment, wiping (wet wiping) is performed by the blade after sufficiently wetting the ejection surface 12A by depositing fine liquid particles 16 on the ejection surface 12A, and therefore adhering matter originating from the ink is dissolved, paper dust and other types of dust and dirt are removed from the ejection surface 12A, and therefore adhering matter attached to the ejection surface 12A are removed reliably. Furthermore, damage to the lyophobic film formed on the ejection surface 12A is prevented.

FIG. 1 shows, as one example of a liquid ejection head which can be used in the present embodiment, a full line type of head having a nozzle row of a length corresponding to at least one edge of the ejection receiving medium (not illustrated), but the present embodiment may also be applied to a serial type of head which performs one liquid ejection operation (in one row or a plurality of rows) in the main scanning direction, while scanning (moving) in the main scanning direction, and when liquid ejection has been completed once in the main scanning direction, the ejection receiving medium is moved through a prescribed amount in the sub-scanning direction, whereupon the liquid ejection in the main scanning direction is carried out again, and by repeating this operation, liquid ejection is carried out over the full surface of the ejection receiving medium.

The cleaning apparatus 10 shown in FIG. 1 comprises: a fine liquid particle generating apparatus 21 constituted by the fine liquid particle outlet port 14 from which the fine liquid particles 16 to be deposited on the ejection surface 12A are sprayed, and a liquid storage chamber 20, connected to the fine liquid particle outlet port 14, which stores the liquid to be sprayed from the fine liquid particle outlet port 14; a carriage 22 which supports the fine liquid particle generating apparatus 21; two guide rails (shafts) 24 which support the carriage 22 movably in the lengthwise direction of the head 12 (main scanning direction) within a plane parallel to the ejection surface 12A; and a carriage 26 which holds the blade 18 while being supported movably in the lengthwise direction of the head 12 on the guide rails 24.

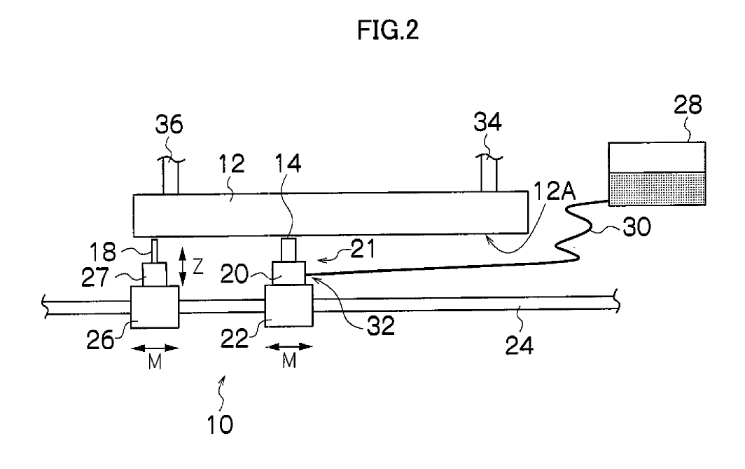

FIG. 2 is a front diagram of the cleaning apparatus 10 and the head 12 shown in FIG. 1.

As shown in FIG. 2, liquid is supplied to the liquid storage chamber 20 of the cleaning apparatus 10 from a liquid tank 28 and via a supply tube 30 and a supply port 32. In other words, the supply port 32 provided in the liquid storage chamber 20 has a structure which is connected to the liquid tank 28 via the supply tube 30.

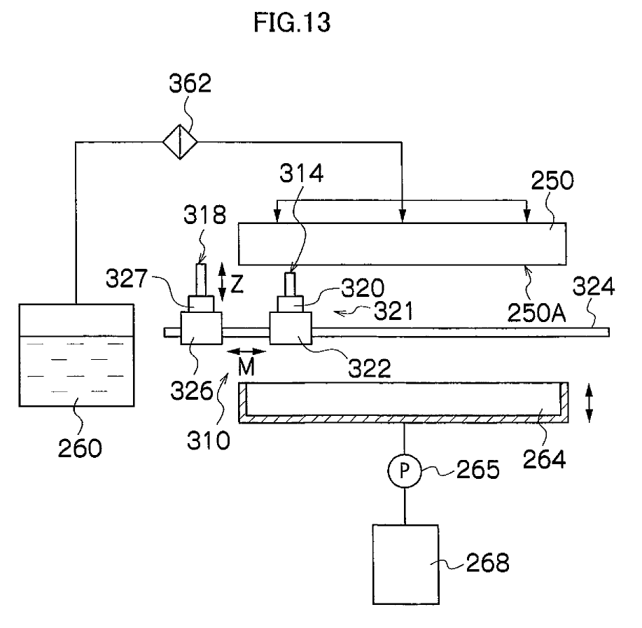

Furthermore, a supply channel 34 and a supply channel 36 forming flow channels for the liquid supplied from a liquid supply tank (not shown in FIG. 2; indicated by reference numeral 260 in FIG. 13) to the head 12 are connected to either end section of the head 12 in the lengthwise direction.

As shown in FIG. 2, the carriage 22 on which the fine liquid particle generating apparatus 21 is installed is composed so as to be movable reciprocally in a direction parallel to the lengthwise direction of the head 12 (main scanning direction), (in other words, in the direction indicated by arrow M in FIG. 2), within a plane parallel to the ejection surface 12A, using a motor (not illustrated) as a drive source. Furthermore, the carriage 26 on which the blade 18 is installed is constituted so as to be movable reciprocally in a direction parallel to the lengthwise direction of the head 12, in a plane parallel to the ejection surface 12A, and furthermore, it comprises an elevator mechanism 27 which moves the blade 18 in the liquid ejection direction of the head 12 (the vertical direction indicated by arrow Z in FIG. 2), thereby switching the ejection surface 12A and the blade 18 between a state of contact and a state of separation.

In other words, the fine liquid particle generating apparatus 21 is moved in the lengthwise direction of the head 12 and deposits fine liquid particles (mist) over the whole surface of the ejection surface 12A, and in a state where the blade 18 has been moved by the elevator mechanism to a position where it abuts against the ejection surface 12A, and the carriage 26 is moved following the carriage 22 in the lengthwise direction of the head 12, whereby the ejection surface 12A which has been wetted by the aggregated fine liquid particles is wiped by the blade 18.

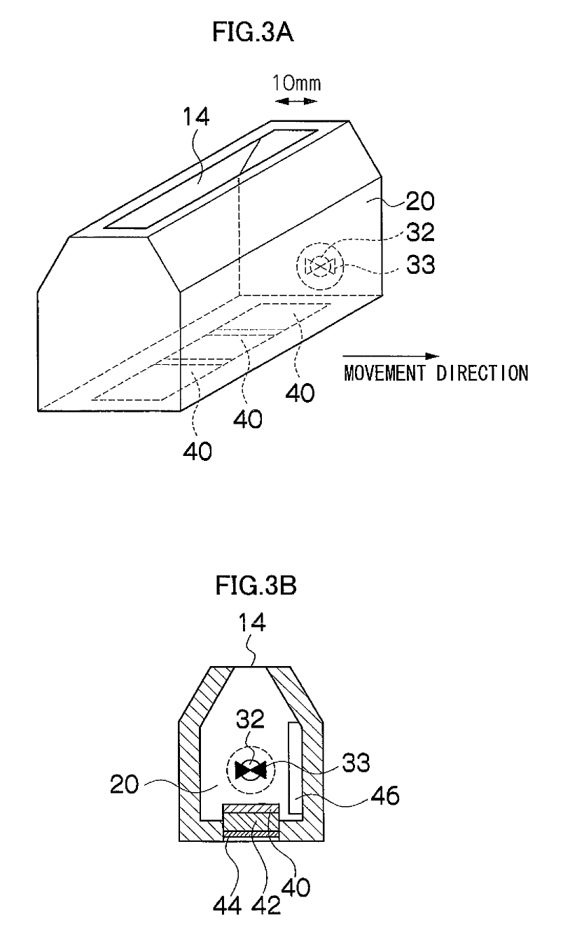

The fine liquid particle generating apparatus 21 comprises a sensor which manages the liquid volume (not shown in FIG. 2, and indicated by reference numeral 46 in FIG. 3B), and a valve (not shown in FIG. 2, and indicated by reference numeral 33 in FIGS. 3A and 3B) which opens and closes the supply port 32 in accordance with the determination results from the sensor. In other words, if the liquid volume inside the fine liquid particle generating apparatus 21 (inside the liquid storage chamber 20) as determined by the sensor is smaller than a prescribed liquid volume, the valve provided in the supply port 32 is opened and liquid is supplied into the fine liquid particle generating apparatus 21 from the liquid tank 28. The supply of liquid from the liquid tank 28 to the fine liquid particle generating apparatus 21 is based on the liquid head pressure differential between the fine liquid particle generating apparatus 21 and the liquid tank 28. In other words, if the determination result from the sensor is smaller than the prescribed liquid volume, then the valve which opens and closes the supply port 32 is opened, and the liquid tank is raised by a movement mechanism (not illustrated) which moves the liquid tank 28 in the vertical direction, thereby supplying liquid from the liquid tank 28 to the fine liquid particle generating apparatus 21 (liquid storage chamber 20).

In the cleaning apparatus 10 shown in the present embodiment, water is used as the liquid for the fine liquid particle generating apparatus 21, from the viewpoint of a cost perspective.

FIG. 3A is an oblique perspective diagram of the fine liquid particle generating apparatus 21, and FIG. 3B is a general cross-sectional diagram showing a schematic view of the structure of the fine liquid particle generating apparatus 21.

As shown in FIG. 3A, the fine liquid particle outlet port 14 is a slit-shaped port, wherein the width (the length in the direction parallel to the direction of movement) is 10 mm, and the length in the direction perpendicular to the direction of movement is a length equivalent to the wiping width on the head surface.

As shown in FIGS. 3A and 3B, diaphragms (pressure plates) 40, the perimeter of which is supported, is provided in the bottom surface of the liquid storage chamber 20 (the surface opposite to the fine liquid particle outlet port 14), and each diaphragm 40 functions as a first electrode of a piezoelectric element 42 which is disposed on the outer side thereof (the side opposite to the liquid storage chamber 20). A second electrode 44 is formed on the surface of the piezoelectric element 42, opposite to the diaphragm 40, and when the piezoelectric element 42 is driven by applying a high-frequency AC (alternate current) voltage equal to or greater than 2.4 MHz and equal to or lower than 100 MHz between the first electrode (diaphragm) 40 and the second electrode 44, then the liquid inside the liquid storage chamber 20 is converted into a mist, and made to flow to the fine liquid particle outlet port 14 which is positioned directly above the piezoelectric element 42.

Since the fine liquid particle outlet port 14 is located in a position in the vicinity of the ejection surface 12A of the head 12, then it is possible to deposit the mist (fine liquid particles) generated by the fine liquid particle generating apparatus 21 onto the ejection surface 12A, without any loss of the mist, and the fine liquid particles deposited on the ejection surface 12A aggregate and wet the ejection surface 12A.

By providing an auxiliary device, such as a duct, between the head 12 and the fine liquid particle outlet port 14, it is possible to reduce the amount of fine liquid particles which flow to the outside of the ejection surface 12A.

One example of conditions for aggregating the fine liquid particles on the ejection surface 12A is, for instance, a situation where the amount of fine liquid particles generated per unit time is 0.8 (ml/sec) and the distance between the fine liquid particle outlet port 14 and the ejection surface 12A is 10 mm. Of course, it is also possible to adopt a composition where the distance between the fine liquid particle outlet port 14 and the ejection surface 12A is variable.

In other words, a required volume of fine liquid particles should be supplied to the ejection surface 12A of the head 12, and if the volume of fine liquid particles generated by the fine liquid particle generating apparatus 21 is small, then the time for applying the fine liquid particles should be set to a long time (in other words, the carriage speed should be set to a slow speed), and the distance should be set to a small distance. By making the opening of the fine liquid particle outlet port 14 equal in size to the wipeable region of the head 12, it is possible to reduce the distance between the ejection surface 12A of the head 12 and the fine liquid particle outlet port 14 of the fine liquid particle generation apparatus to approximately 1 mm. Consequently, it is possible to deposit the generated mist efficiently onto the ejection surface 12A of the head 12, and impediments, such as the fine liquid drops adhering to and condensing on other members, can be prevented.

On the other hand, if the distance between the fine liquid particle generating apparatus 21 and the ejection surface 12A is too small, then there is a concern that the fine liquid particle generating apparatus 21 and the ejection surface 12A will make contact with each other, and therefore high precision is required in the conveyance of the carriage and costs increase. In the present embodiment, from the viewpoints of the fine liquid particle generation capacity of the fine liquid particle generating apparatus 21 and the cost, the distance between the fine liquid particle outlet port 14 and the ejection surface 12A is determined as described above.

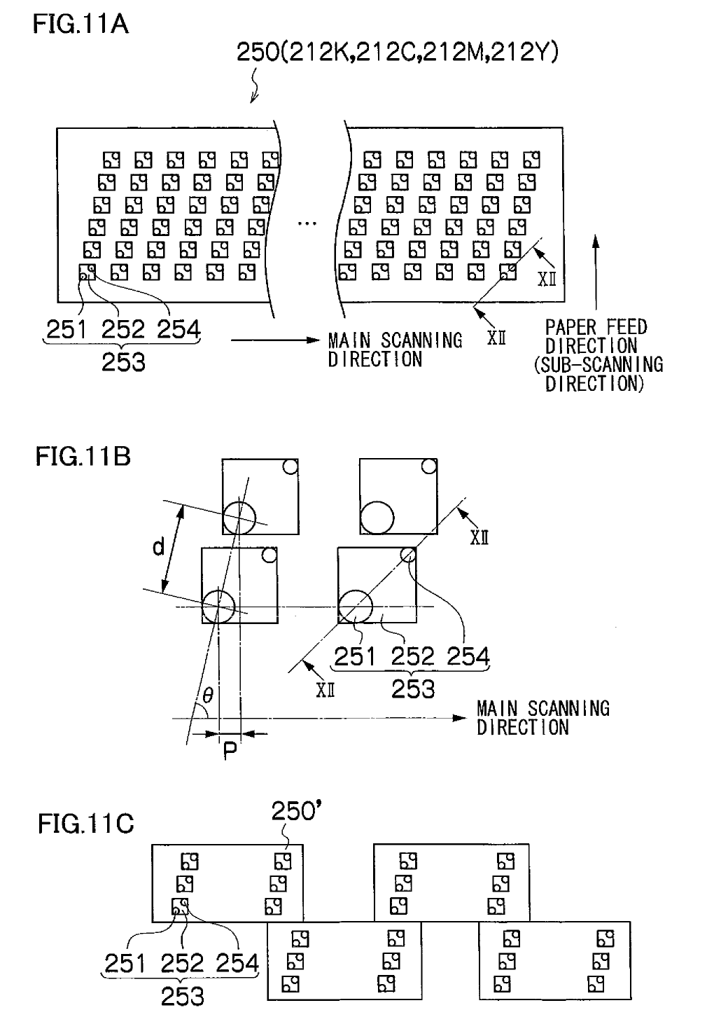

In other words, the fine liquid particle generating apparatus 21 shown in the present embodiment sprays fine liquid particles by means of the vibrational pressure (vibrational energy) used to convert the liquid into a mist, without using pressurization by means of a pump, or the like, and therefore the fine liquid particles do not penetrate deeply inside the nozzles (indicated by reference numeral 251 in FIGS. 11A to 11C) of the head 12, and the meniscus is not broken down.

As a secondary beneficial effect, since fine liquid particles are supplied to the vicinity of the meniscus forming position inside the nozzles of the head 12 (the vicinity of the nozzle openings), then a beneficial effect is obtained in alleviating the increase in the viscosity in the vicinity of the meniscus, by means of the fine liquid particles which adhere to the surface of the meniscus.

On the other hand, since the fine liquid particles enter inside the nozzles of the liquid ejection head 12, then there is a concern about decline in the concentration of the liquid to be ejected in the next liquid ejection operation which is to be carried out after the wiping operation. However, even if a film of water having a thickness of 50 μm is formed inside a nozzle having a diameter of 30 μm, when this film of water is converted into a volume, the resulting figure is approximately several tens of pl, and this film of water formed by aggregation of the fine liquid particles that have entered inside the nozzles is removed entirely by the purging that is generally carried out after wiping (and before the next liquid ejection operation), and hence the concerns about decline in concentration do not pose an actual problem.

Furthermore, the water level sensor 46 which determines the level of water inside the liquid storage chamber 20 is provided inside the liquid storage chamber 20 shown in FIG. 3B. The level of the liquid inside the liquid storage chamber 20 is judged on the basis of the determination signal obtained from the level sensor 46, and if it is judged that the water level is lower than a previously set level, then the valve 33 provided between the supply port 32 and the liquid storage chamber 20 is opened, and liquid is supplied from the liquid tank (see FIG. 2) into the liquid storage chamber 20. When liquid has been replenished into the liquid storage chamber 20 and has reached the prescribed level, the valve 33 is closed and the supply of liquid is terminated.

The present embodiment is described above with respect to a mode where the level of the liquid in the liquid storage chamber 20 is determined by means of the level sensor 46, but it is also possible to employ another mode, such as a mode where the volume of liquid inside the liquid storage chamber 20 is judged by determining the mass of the liquid inside the liquid storage chamber 20. Furthermore, the volume of liquid replenished into the liquid storage chamber 20 may be determined from determination information obtained from the level sensor 46, or it may be determined on the basis of the time elapsed from the time at which the valve 33 is opened, or the residual amount of liquid in the liquid tank 28 (see FIG. 2).

In FIGS. 3A and 3B, the wiring which transmits the high-frequency AC voltage applied to the piezoelectric element 42, the sensor wiring which transmits determination signals from the level sensor 46, the cover member which protects the piezoelectric element 42 in such a manner that the piezoelectric element 42 does not make contact with other members, and the like, are omitted from the drawing.

### Description of Control System

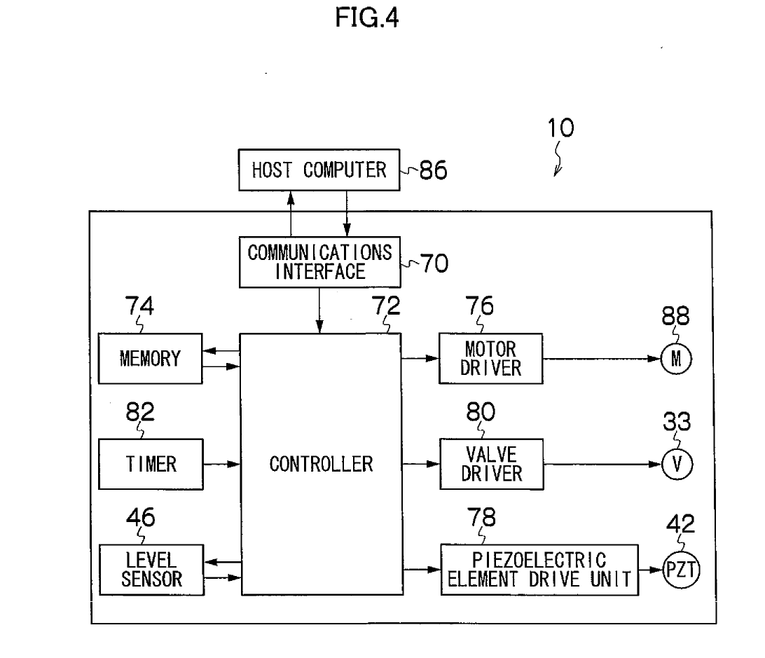

FIG. 4 is a schematic block diagram showing the system configuration of the cleaning apparatus 10. As shown in FIG. 4, the cleaning apparatus 10 comprises a communications interface 70, a system controller 72, a memory 74, a motor driver 76, a piezoelectric element drive unit 78, a valve driver 80, a timer 82, a level sensor 84, and the like.

The communications interface 70 is an interface unit for receiving data sent from a host computer 86. A serial interface such as USB (Universal Serial Bus), IEEE1394, Ethernet (registered trademark), wireless network, or a parallel interface such as a Centronics interface may be used as the communications interface 70. A buffer memory (not shown) may be mounted in this portion in order to increase the communication speed. The data sent from the host computer 86 is received by the cleaning apparatus 10 through the communications interface 70, and is temporarily stored in the memory 74.

The memory 74 is a storage device for temporarily storing data inputted through the communications interface 70, and data is written and read to and from the memory 74 through the system controller 72. The memory 74 is not limited to a memory composed of semiconductor elements, and a hard disk drive or another magnetic medium may be used.

The system controller 72 is constituted by a central processing unit (CPU) and peripheral circuits thereof, and the like, and it functions as a control device for controlling the whole of the cleaning apparatus 10 as well as a calculation device for performing various calculations in accordance with prescribed programs. More specifically, the system controller 72 controls the various sections, such as the communications interface 70, memory 74, motor driver 76, piezoelectric element drive unit 78, and the like, controls communications with the host computer 86, controls writing and reading to and from the memory 74, and also generates control signals for controlling the motor 88 of the conveyance system and various movement mechanisms.

The programs executed by the CPU of the system controller 72 and the various types of data which are required for control procedures are stored in the memory 74. The memory 74 may be a non-writeable storage device, or it may be a rewriteable storage device, such as an EEPROM. The memory 74 is used as a temporary storage region for the data, and it is also used as a program development region and a calculation work region for the CPU.

The motor driver 76 is a driver that drives the motor 88 in accordance with commands from the system controller 72. In FIG. 4, a lot of motors (actuators) disposed in the sections of the cleaning apparatus 10 are represented by the reference numeral 88. For example, the motor 88 illustrated in FIG. 4 includes motors forming drive sources for the carriage 22 and carriage 26 in FIG. 2, a motor for the elevator mechanism which moves the blade 18 in the vertical direction, and so on.

The piezoelectric element drive unit 78 is a drive circuit which drives the piezoelectric element by applying a high-frequency AC voltage of 2.4 MHz or above to the piezoelectric element 42, in accordance with instructions from the system controller 72. The piezoelectric element drive unit 78 comprises a power source unit which generates a high-frequency AC voltage, a control unit which controls the frequency and amplitude (voltage) of the high-frequency AC voltage, and a drive circuit (output circuit) which applies the high-frequency AC voltage to the piezoelectric element 42.

The valve driver 80 controls the opening and closing of the valve 33 which is provided between the liquid storage chamber 20 and the supply port 32, under the control of the system controller 72.

The timer 82 counts the elapsed time from the application of the drive voltage to the piezoelectric elements 42 (the start of driving of the piezoelectric elements 42), and supplies the timer value (count value) obtained at a prescribed timing to the system controller 72. The system controller 72 stores and continually rewrites the timer value sent by the timer 82, and by controlling the on and off switching of the piezoelectric elements 42 on the basis of this timer value, it controls the amount of fine liquid particles deposited onto the ejection surface 12A.

The level sensor 46 determines the level of the liquid inside the liquid storage chamber 20 (see FIGS. 3A and 3B). The determination signals from the level sensor 46 are sent to the system controller 72, and the system controller 72 sends control signals to the respective units on the basis of the level information for the liquid storage chamber 20 obtained from the level sensor 46, in such a manner that liquid is replenished into the liquid storage chamber 20, as and when appropriate.

The composition of the control system shown in FIG. 4 is merely one example, and the memory 74 and the timer 82 may use functions built into the processor which constitutes the system controller 72, or alternatively, a memory (not illustrate) and calculating function block (controller) may be appended to various device drivers, such as the motor driver 76.

### Description of Example of Control of Fine Liquid Particle Generation Apparatus and Blade

Next, one example of the control of the fine liquid particle generation apparatus and the blade will be described. In the present example, a composition is described in which the fine liquid particle generating apparatus 21 and the blade 18 are mounted on respectively independent carriages 22 and 26, and are moved over the same guide rails 24. In other words, by controlling the time period until the start of operation of the carriage 26 on which the blade 18 is mounted, after the start of the spraying of fine liquid particles onto the ejection surface 12A from the fine liquid particle outlet port 14, it is possible to vary the period of time from wetting of the ejection surface 12A until wiping. Consequently, if it is estimated that the soiling of the ejection surface 12A is very bad, then it is possible sufficiently to dissolve the adhering material originating from the ink, by making the time period from wetting until wiping relatively long.

On the other hand, it is also possible to employ a mode where the carriage 22 on which the fine liquid particle generating apparatus 21 is mounted and the carriage 26 on which the blade 18 is mounted are unified, in such a manner that the fine liquid particle generating apparatus 21 and the blade 18 are mounted on the same carriage. If the fine liquid particle generating apparatus 21 and the blade 18 are mounted on the same carriage, then it is possible to simplify the composition of the movement mechanism of the fine liquid particle generating apparatus 21 and the blade 18, in addition to which the control of the movement of the fine liquid particle generating apparatus 21 and the blade 18 is also simplified.

Moreover, by adjusting the amplitude and frequency of the AC voltage applied to the piezoelectric elements 42, it is possible to vary the amount of fine liquid particles sprayed from the fine liquid particle outlet port 14. For example, if the amplitude of the AC voltage is made large, then the amount of fine liquid particles sprayed from the fine liquid particle outlet port 14 becomes relatively large, and if the frequency of the AC voltage is raised, then the amount of the fine liquid particles sprayed from the fine liquid particle outlet port 14 becomes relatively small.

Moreover, the amount of the fine liquid particles sprayed from the fine liquid particle outlet port 14 is directly proportional to the elapsed time from the timing at which spraying of fine liquid particles is started, and therefore the elapsed time from the timing of the start of spraying of fine liquid particles is counted, using the timer 82 shown in FIG. 4, and by controlling the on and off switching of the piezoelectric elements 42 on the basis of this count value (or by controlling the movement speed or halting of the carriage 22), it is possible to vary the amount of fine liquid particles sprayed per unit surface area onto the ejection surface 12A.

If the ejection surface 12A is wetted excessively, then trickling of the liquid occurs, and a large amount of the liquid used for wetting the ejection surface 12A is consumed wastefully. On the other hand, if the amount of fine liquid particles used to wet the ejection surface 12A is too small, then it is difficult to remove the adhering material attached to the ejection surface 12A, satisfactorily, and furthermore, damage may be caused by the blade 18 to the lyophobic film on the ejection surface 12A.

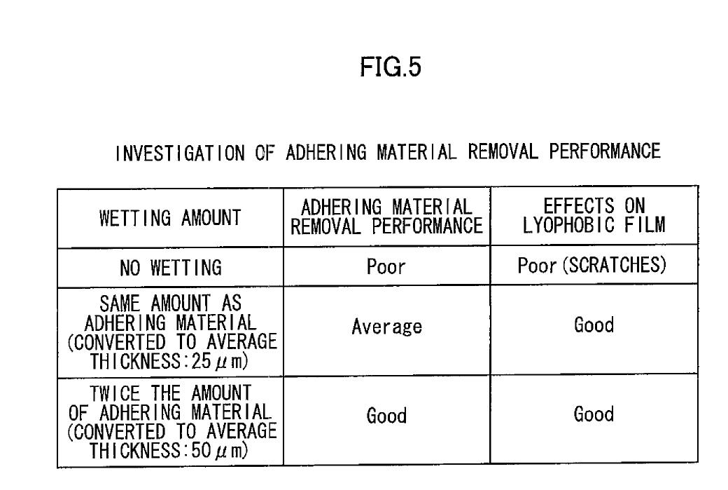

FIG. 5 shows the relationship between the amount of wetting of the ejection surface 12A (the amount of fine liquid particles deposited on the ejection surface 12A), and the properties in removing adhering material from the ejection surface 12A. In investigating the adhering material removing properties shown in FIG. 5, the amount of wetting was calculated by measuring the mass per unit surface area of the fine liquid particles attached to the ejection surface 12A (the fine liquid particles having an average diameter of 3 μM generated by applying an AC voltage of 2.4 MHz to the piezoelectric elements 42), converting the measured mass into a volume, and then calculating an average thickness per unit surface area, accordingly. The amount of fine liquid particles generated was 0.8 ml/sec, and the ejection surface 12A was provided so as to be opposite the fine liquid particle outlet port 14, at a position distanced by some 10 mm from the fine liquid particle outlet port 14.

Furthermore, a pigment-based ink for a commercial inkjet printer was used as the adhering material, and was dried in an air flow created by a drier, and the drying rate of the adhering material (=the ratio of the mass after drying/the mass before drying) was 50% to 90%, and the average thickness was 25 μm.

The adhering material removal properties and the effects on the lyophobic film were evaluated functionally by visually observing the state on the ejection surface 12A (the state of the residual ink, and the lyophobic film) after wiping the ejection surface 12A with a rubber blade having a thickness of 1 mm.

As shown in FIG. 5, it was confirmed that, if the ejection surface 12A is not wetted (no wetting), then adhering material of a level which can be confirmed visually is left remaining on the ejection surface 12A (evaluation: Poor in FIG. 5). Furthermore, the presence of scratches which can be confirmed visually was also observed in the lyophobic film (evaluation: Poor in FIG. 5).

When the fine liquid particles of substantially the same volume as the adhering material (an average thickness of 25 μm) were deposited on the ejection surface 12A, then although it was difficult to confirm visually, adhering material which could be confirmed when magnified by several times with a microscope, or the like, was observed to be left remaining (evaluation: Average in FIG. 5). On the other hand, scratching of the lyophobic film was not observed (evaluation: Good in FIG. 5).

If the fine liquid particles of approximately twice the amount of the adhering material (average thickness of 50 μm) were deposited on the ejection surface 12A, then no adhering material was observed (evaluation: Good in FIG. 5), and no scratching of the lyophobic film was observed either (evaluation: Good in FIG. 5).

In other words, the amount of fine liquid particles generated, the movement speed of the carriage 22 on which the fine liquid particle generating apparatus 21 is mounted, and the movement start timing and the movement speed of the carriage 26 on which the blade 18 is mounted, are each set appropriately in such a manner that the amount of fine liquid particles deposited onto the ejection surface 12A is twice or more times greater than the amount of adhering material adhering to the ejection surface 12A.

A desirable mode is one where the amount of adhering material adhering to the ejection surface 12A is estimated in advance by previous assessment, since it is governed by the properties of the ink. Furthermore, if the number of days (time) from the start of the use of the ink, or the number of ejection receiving media which have received ejection of liquid, exceeds a certain prescribed value, or if the temperature and humidity are lower than standard values, then the viscosity of the ink adhering to the ejection surface 12A rises and it becomes more difficult to remove it by wiping. Therefore, a desirable mode is one where the amount of the fine liquid particles deposited on the ejection surface 12A is made relatively greater, in cases such as these.

On the other band, in the present example, if the fine liquid particle outlet port 14 is fixed and supplies fine liquid particles continuously to the same position on the ejection surface 12A for a period of 12 seconds, then a “trickling” effect (an effect where the liquid drips off the ejection surface 12A) occurred. The amount of fine liquid particles in this case was 10 (ml) per unit surface area. Consequently, the amount of fine liquid particles deposited on the ejection surface 12A must be equal to or less than 10 (ml) per unit surface area. The conditions which give rise to “trickling” of the fine liquid particles deposited on the ejection surface 12A vary depending on the lyophobic properties of the ejection surface 12A, and therefore the conditions for preventing “trickling”, (the continuous fine liquid particle generation time, and so on) must be determined in advance.

By adopting the cleaning apparatus 10 for the ejection surface 12A of a liquid ejection head 12 having the composition described above, the fine liquid particles generated by the fine liquid particle generating apparatus 21 are deposited on the ejection surface 12A and caused to aggregate on the ejection surface 12A solely by the generating pressure of the fine liquid particles, and therefore the ejection surface 12A can be wetted satisfactorily without breaking down the meniscus formed inside the nozzles of the liquid ejection head. Consequently, the ejection surface 12A is wiped by the blade 18 in a “wet wiping” action, the performance in removing adhering material is improved, and scratching of the lyophobic film formed on the ejection surface 12A is also prevented.

Moreover, using water in order to generate the fine liquid particles is beneficial in cost terms, and is also desirable from an environmental point of view. By making the amount of fine liquid particles deposited on the ejection surface 12A at least twice greater than the amount of adhering material, a desirable wetted state is achieved on the ejection surface 12A, the performance in removing adhering material is improved, and scratching of the lyophobic film is prevented. What is more, “trickling” of the fine liquid particles is prevented by setting the amount of fine liquid particles deposited on the ejection surface 12A to be equal to or less than 10 (ml) per unit surface area.

### Second Embodiment

### Composition of Cleaning Apparatus

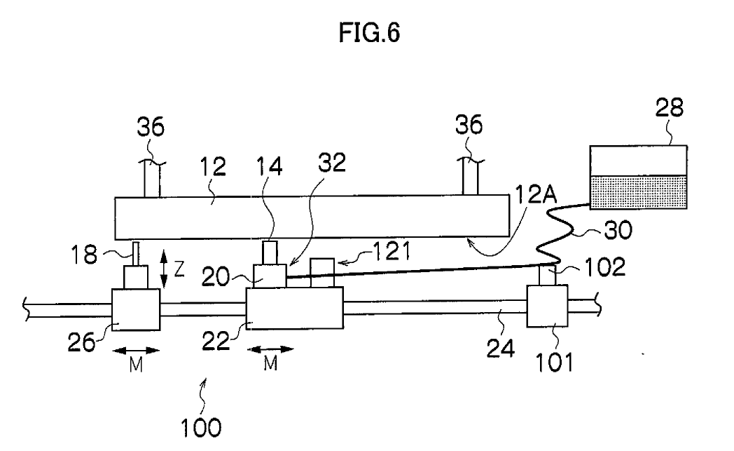

Next, a cleaning apparatus according to a second embodiment of the present invention will be describe. FIG. 6 shows a front view diagram of a cleaning apparatus 100. In FIG. 6, parts which are the same as or similar to FIG. 2 are labeled with the same reference numerals and further explanation thereof is omitted here.

The cleaning apparatus 100 shown in FIG. 6 differs from the cleaning apparatus 10 shown in FIG. 2 in that it comprises an adhering material determination sensor 102 which determines adhering material on the ejection surface 12A of the head 12. In other words, in the cleaning apparatus 100 shown in FIG. 6, the adhering material determination sensor 102 is installed on a carriage 101, which is independent of the carriage 22 on which the fine liquid particle outlet port 14 and the liquid storage chamber 20 are mounted.

More specifically, the carriage 101 which is movable in the lengthwise direction of the head 12 in a plane parallel to the ejection surface 12A, and on which the adhering material determination sensor 102 is mounted, is supported on the guide rails 24, and in FIG. 6, the adhering material determination sensor 102, a fine liquid particle generation apparatus 121, and the blade 18 are disposed in this sequence from the right-hand side, and respectively move in one direction from left to right in FIG. 6, in order to carry out the processes of scanning (moving), spraying fine liquid particles, and wiping, sequentially, with respect to the ejection surface 12A.

A CCD, a CMOS, or a photointerruptor including a light-emitting element and a light-receiving element, or the like, is suitable for use as the adhering material determination sensor 102. If an imaging element such as a CCD, CMOS, or the like, is used for the adhering material determination sensor 102, then it is possible to judge the presence of adhering material and the size of the adhering material by analyzing the image captured by that imaging element (the read image).

Furthermore, if a photointerruptor is used for the adhering material determination sensor 102, then it is also possible to judge the presence or absence of adhering material on the basis of the presence or absence of reflected light (received by the light-receiving element) which has been emitted by the light-emitting element and reflected by the ejection surface 12A.

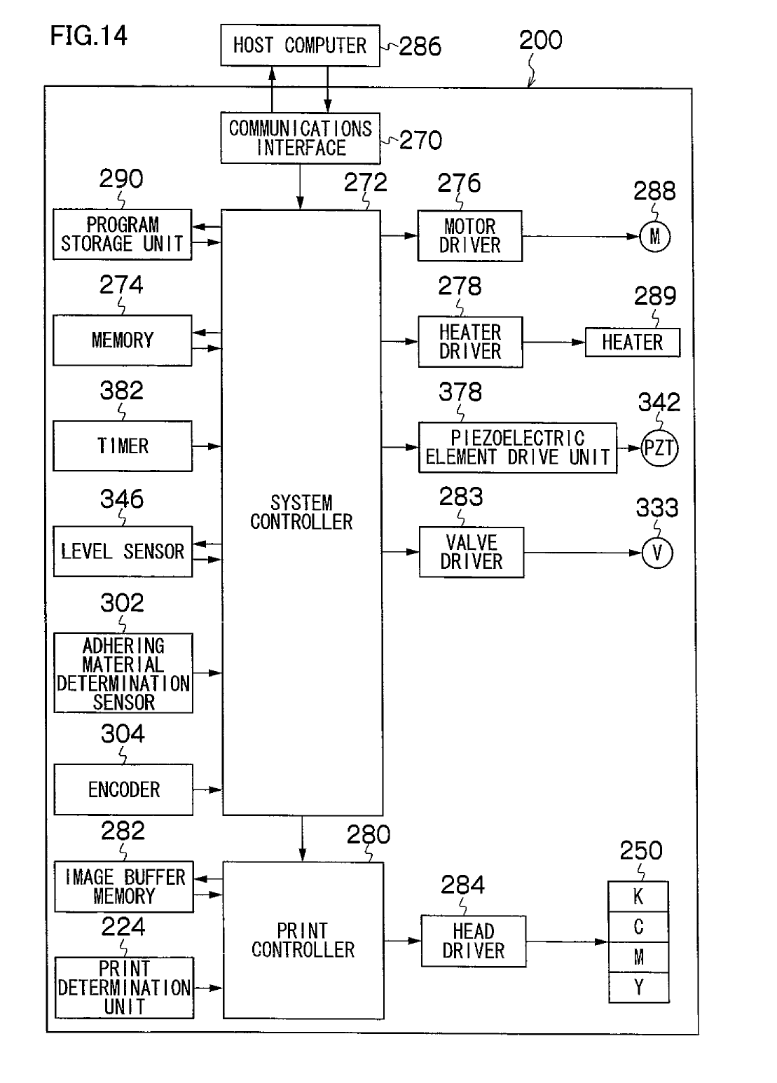

By previously storing the position of the carriage 101 on which the adhering material determination sensor 102 is mounted, it is possible to identify the position of the adhering material on the ejection surface 12A. One example of a method of storing the position of the carriage 101 is to adopt a composition where an encoder (not illustrated in FIG. 6 and indicated by reference numeral 304 in FIG. 14) is installed on the motor which drives the carriage 22, in such a manner that the number of output pulses from the encoder are counted, this pulse count value being stored and the position of the carriage 101 being judged on the basis of the stored pulse count value.

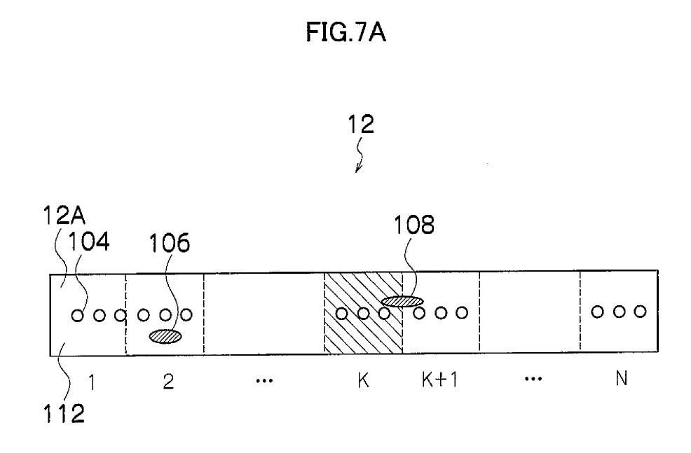

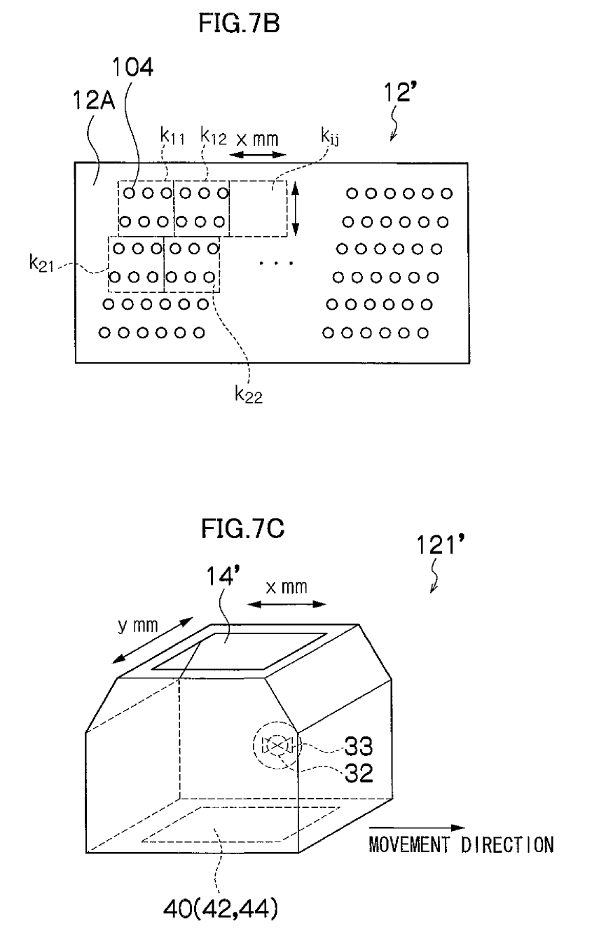

Here, one concrete mode of a method of identifying the position of adhering material on the ejection surface 12A will be described. As shown in FIG. 7A, the head 12 is divided into N areas 112 (1 to N) in the main scanning direction, and the presence or absence of adhering material is judged by scanning each area by means of the adhering material determination sensor 102 (see FIG. 6). The position of the carriage 22 at the timing that adhering material is determined is judged from the pulse count value of the encoder, and it is thereby judged in which area the adhering material is positioned.

In the present example, N areas 112 (1, 2, . . . , k, k+1, . . . , N) are set in such a manner that there is an equal number of nozzles 104 in each of the areas (in such a manner that the surface area of each area on the ejection surface 12A is equal).

In an area where the presence of adhering material has been determined, the thickness of the adhering material (average thickness) is determined. If an imaging element such as a CCD or CMOS is used for the adhering material determination sensor 102, then the thickness of the adhering material is determined by analyzing the image (read image) captured by the imaging element, and if a photointerruptor is used as the adhering material determination sensor 102, then the thickness of the adhering material is determined on the basis of the amount of reflected light (received by the light-receiving element) which has been emitted from the light-emitting element and reflected by the ejection surface 12A.

The reference numeral 106 in FIG. 7A indicates adhering material which is attached to the second block and the reference numeral 108 indicates adhering material which is attached to a region spanning the k^{th} area and the k+1^{th} area. If the adhering material is present in a region spanning a plurality of areas, as in the case of the adhering material 108, then it is possible either to determine the thickness of the adhering material in the respective areas only from the portions of adhering material contained in respective areas, or to determine the thickness of the adhering material in each of the areas from the thickness (average thickness, maximum thickness) of the whole of the adhering material.

Furthermore, although not shown in the drawings, if there are a plurality of adhering materials present in one area, then the average thickness of all of the adhering materials in that area may be taken as the thickness of the adhering material in the area, or alternatively, the maximum value of the thickness of the adhering materials in that area may be taken as the thickness of the adhering material in the area.

When the thickness of the adhering material has been determined in this way for each area where the presence of adhering material has been determined, then the amount of fine liquid particles to be deposited on each of the areas is decided.

In FIG. 7A, the areas are divided up one-dimensionally, but in a line type of head 12′ or a head 12′ in which nozzles are arranged in a matrix configuration, as shown in FIG. 7B, a desirable mode is one where the areas are divided up two-dimensionally, the method of dividing up the areas being decided appropriately in accordance with the shape of the ejection surface 12A and the size of the fine liquid particle outlet port 14′ of the fine liquid particle generating apparatus 121′ shown in FIG. 7C. In other words, if the ejection surface 12A is divided into m×n areas based on a unit surface area in the ejection surface 12A upon which the fine liquid particles sprayed from one fine liquid particle outlet port 14′ are deposited, (namely, the areas k₁₁, k₁₂, . . . , k₂₁, k₂₂, . . . , kᵢⱼ, . . . , kₘₙ in FIG. 7B), then it is possible to deposit fine liquid particles onto the ejection surface 12A efficiently, without any no need for duplicated scanning by the fine liquid particle outlet port 14′ (duplicated moving of the fine liquid particle outlet port 14′). In the example shown in FIG. 7A, the size of each of the areas is taken as 30 mm, and in the examples shown in FIGS. 7B and 7C, the size of one area is x(mm)×y(mm), in accordance with the size x(mm)×y(mm) of the fine liquid particle outlet port 14′ shown in FIG. 7C. Of course, it is possible to make x(mm)=y(mm).

In the present example, the adhering material determination sensor 102 is provided on the carriage 101 which is independent of the carriage 22 on which the fine liquid particle generating apparatus 21 is mounted, and the adhering material on the ejection surface 12A is determined independently of and prior to the fine liquid particle generating apparatus 21, but it is also possible to install the adhering material determination sensor 102 on the carriage 22 on which the fine liquid particle generating apparatus 21 is mounted.

### Example of Control of Cleaning Apparatus

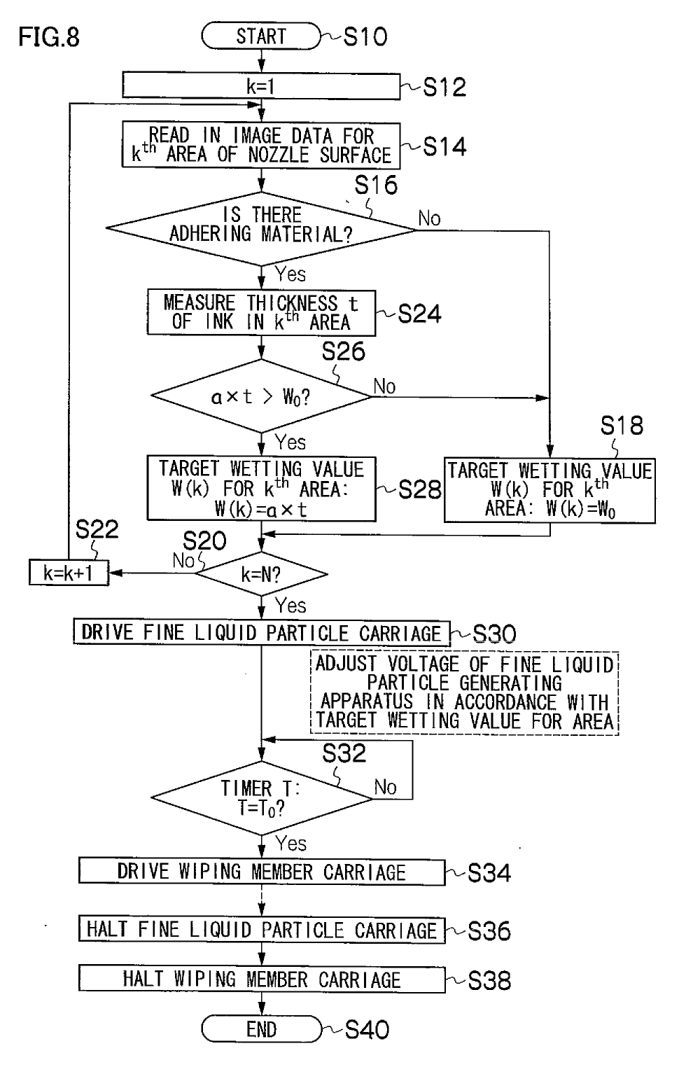

Next, one example of the control of maintenance of the liquid ejection surface according to the present example will be described with reference to FIG. 8. FIG. 8 is a flowchart showing sequence of control of the cleaning apparatus 100 relating to the second embodiment.

As shown in FIG. 8, when the maintenance control procedure is started (step S10), scanning (sensing) of the ejection surface 12A is carried out by the adhering material determination sensor (area CCD) 102, while scanning (moving) the carriage 101 (see FIG. 6) in the lengthwise direction of the head 12. The scanning of the ejection surface 12A is carried out in sequence from the first area (k=1) to the N^{th} area (k=N) shown in FIG. 7A.

Scanning of the k^{th} area (k=1) is carried out (step S12 in FIG. 8), and the image data for the k^{th} area as captured by the adhering material determination sensor 102 is read in (is obtained) (step S14).

Inage processing (for example, outline extraction, comparison with a reference image where there is no adhering material, color extraction, and the like) is carried out on the basis of the image data read in at step S14, and the presence or absence of adhering material in the k^{th} area is investigated (step S16).

At step S16, if it is judged that adhering material is not present on the area (NO verdict), a reference wetting amount W₀ is set as the target wetting amount (target wetting value) W(k) of the k^{th} area (step S18). Here, the target wetting amount W(k) is expressed as the thickness of the fine liquid particles (unit: μm) on the ejection surface 12A. Moreover, the reference wetting amount W₀ is the wetting amount such that no scratches, and the like, are caused even if the lyophobic film on the ejection surface 12A (see FIG. 6) is wiped with the blade 18. If the reference wetting amount W₀ is too small, then although there is no problem in an initial state, scratching of the lyophobic film may occur over time because of temporal changes in the blade 18 and the lyophobic film. On the other hand, if the reference wetting amount W₀ is too great, then the amount of wasted fine liquid particles increases.

Consequently, the appropriate value of the reference wetting amount W₀ varies depending on the properties of the lyophobic film, the properties of the ink, the material of the blade 18, and the pressure during wiping of the blade 18 (the contact pressure of the blade 18 against the ejection surface 12A), and therefore the reference wetting amount must be determined in advance in accordance with the parameters described above. In the present example, taking these parameters into consideration, the reference wetting amount W₀ is set to W₀=25 (μm). In other words, fine liquid particles of 3 (mm)×3 (mm)×0.025 (mm)=0.225 (ml) are deposited on areas where there is no adhering material.

Thereupon, it is judged whether or not the current area is the final area (whether or not k=N) (step S20), and if the area is not the final area (k≠N) (NO verdict), then the procedure advances to step S22, the next area (k=k+1) is set, and scanning of the next area is carried out (step S14).

On the other hand, at step S16, if it is judged that there is adhering material present on the current area (YES verdict), then the thickness t of the adhering material on that area (principally, the thickness of the ink) is measured (step S24).

The method of measuring the thickness t of the adhering material in the present example is constituted by the steps described below.

(1) While the adhering material determination sensor 102 is moved in the normal direction to the ejection surface 12A by operating a movement mechanism for moving the adhering material determination sensor 102 in the normal direction to the ejection surface 12A, the k^{th} area is imaged at least once (and desirably twice or more times).

(2) The data which is captured (image-captured) and stored on a prescribed storage medium at step S14, and the image data which is captured and recorded on a prescribed storage medium at step S24, are subject to image processing, and the magnitude of the contrast between the image data captured at step S14 and the image data captured at step S24 is determined.

(3) The thickness t of the adhering material is determined on the basis of the image-capturing position of the adhering material determination sensor 102 (the distance through which the optics system of the adhering material determination sensor 102 has been moved) when a contrast equal to or greater than a prescribed threshold value is obtained.

A desirable mode is one where the thickness t of the adhering material is represented by the average thickness of the adhering material (the average value of the thicknesses measured at a plurality of positions in the adhering material).

In the present example, an area CCD is used as the adhering material determination sensor 102, but a desirable mode is one comprising a laser irradiation unit, a light receiving unit which determines reflected light of the laser light, and an optics system which carries out optical correction with respect to the reflected light. In other words, it is possible to determine the presence of adhering material and to determine the thickness t of the adhering material, with great accuracy, by using laser light.

When the thickness t of the adhering material in the k^{th} area has been measured at step S24, the target wetting amount W(k) is determined on the basis of the thickness t of the adhering material of the area in question. If “α” represents the target wetting value coefficient per unit thickness of the adhering material, then when the thickness of the adhering material is designated by “t”, the target wetting amount W(k) is represented as W(k)=α×t, and the reference wetting amount W₀, which is the target wetting amount where there is no adhering material, is compared with α×t (step S26).

If, at step S26, α×t is equal to or smaller than W₀ (NO verdict), then the procedure advances to step S18, and the reference wetting amount W₀ is set as the target wetting amount for the area in question. On the other hand, at step S26, if α×t is greater than W₀ (YES verdict), the procedure advances to step S28, W(k)=α×t is set as the target wetting amount for the area, and the procedure then advances to step S20.

At step S20, if it is judged that the target wetting amount has been set for all of the areas (k=N) (YES verdict), then the procedure advances to step S30, where the carriage 22 (see FIG. 6) on which the fine liquid particle generating apparatus 21 (121) is mounted is driven, and furthermore the fine liquid particle generating apparatus 21 (121) is driven on the basis of the target wetting amount W(k) set for the respective areas, thereby spraying the fine liquid particles onto the respective areas.

As a concrete example of the control of spraying fine liquid particles, there is a mode where the change in the wetting amount based on the driving voltage of the piezoelectric elements 42 (see FIG. 3B) of the fine liquid particle generating apparatus 21 is determined in advance; when switching between areas, the target wetting amount W(k) for the area onto which fine liquid particles are to be sprayed subsequently is compared with the target wetting amount W(k−1) for the preceding area; and the drive voltage of the piezoelectric element 42 is controlled in such a manner that: if W(k)>W(k−1), then the drive voltage of the piezoelectric element 42 is set to a relatively high voltage, whereas if W(k)<W(k−1), then the drive voltage of the piezoelectric element 42 is set to a relatively low voltage.

In other words, a desirable mode is one where the amount of change of the drive voltage, ΔV, with respect to the amount of change of the wetting amount, ΔW, is stored in advance in the form of a data table, in such a manner that the amount of change ΔV of the drive voltage is read out appropriately from the data table in accordance with the amount of change ΔW of the wetting amount. Furthermore, a desirable mode is one where: a calculation formula (calculation sequence) which stipulates the relationship between the target wetting amount W(k) and the drive voltage of the piezoelectric elements 42 is determined in advance, and when the target wetting amount W(k) has been set, the drive voltage of the piezoelectric element 42 is determined by calculation on the basis of the set target wetting amount.

Moreover, at step S32, the elapsed time from the start of wetting (for example, the start of driving of the piezoelectric elements 42) is counted, the count is continued until the time value T has satisfied T=T₀ (NO verdict), and if the timer value T satisfies T=T₀ (YES verdict), then the carriage 26 on which the blade 18 (see FIG. 6) is mounted is driven (step S34).

In other words, in order to dissolve the solidified ink and to remove dirt, and the like, from the ejection surface 12A, in each of the areas, then the waiting time T₀ from the start of spraying of fine liquid particles until the start of wiping is set. Here, the waiting time T₀ is set to a fixed value, but a desirable mode is one where a plurality of waiting times are selected appropriately in accordance with the state of the adhering material on the area in question.

At step S34, when the spraying of fine liquid particles by the fine liquid particle generating apparatus 121 and wiping by the blade 18 have been completed with respect to the k^{th} area, then the spraying of fine liquid particles by the fine liquid particle generating apparatus 121 and wiping by the blade 18 are carried out with respect to the next area (the k+1^{th} area).

In this way, the processing from step S12 to step S34 is carried out sequentially for each area, and when the maintenance has been completed for the first area to the N^{th} area of the ejection surface 12A, then the carriage 22 on which the fine liquid particle generating apparatus 121 is mounted is hatted (step S36), the carriage on which the blade 18 is mounted is halted (step S38), and the control of maintenance of the liquid ejection surface terminates (step S40).

In a mode where the adhering material determination sensor 102 and the fine liquid particle generating apparatus 121 are mounted on a common (the same) carriage 22, then it is desirable that the spraying of fine liquid particles by the fine liquid particle generating apparatus 121 should be carried out in a continuous fashion after scanning of the ejection surface 12A (namely, that determination of the adhering material should be carried out for the area where maintenance is to be carried out next, while fine liquid particles are being sprayed).

In the present embodiment, a mode is described in which the adhering material determination sensor 102, the fine liquid particle generating apparatus 121 and the blade 18 are moved in one direction, and scanning of the ejection surface 12A, spraying of fine liquid particles and wiping are carried out in sequence, but a desirable mode is one where the adhering material determination sensor 102, the fine liquid particle generating apparatus 121 and the blade 18 are movable reciprocally back and forth, scanning of the ejection surface 12A, spraying of fine liquid particles and wiping being carried out in the outward movement direction, and scanning of the ejection surface 12A being carried out, without spraying of fine liquid particles and wiping, in the return movement direction, whereby the state of the ejection surface 12A after wiping is judged (namely, whether or not the adhering material has been removed by the wiping action carried out in the outward movement direction), and if the adhering material has not been removed by the wiping carried out in the outward movement direction, then the spraying of fine liquid particles and wiping are carried out again in the outward movement direction.

In the second maintenance operation, the target wetting amount W(k) may be changed in comparison with the first maintenance operation. Furthermore, a desirable mode is one where, in the second maintenance operation, it is judged whether or not maintenance has been carried out, with respect for each area.

According to the cleaning apparatus 100 having the composition described above, the presence or absence of adhering material on the ejection surface 12A, and the position and thickness of the adhering material, are determined, and in areas where adhering material has been determined, the wetting amount for those areas (the amount of fine liquid particles deposited onto those areas) is set in accordance with the thickness of the adhering material, thereby controlling the amount of fine liquid particles generated and also controlling the amount of wetting of the ejection surface. Consequently, the wetting amount is optimized for each area, the performance in removing adhering material is improved, and reducing amount of wasted fine liquid particles is promoted.

### Application Example

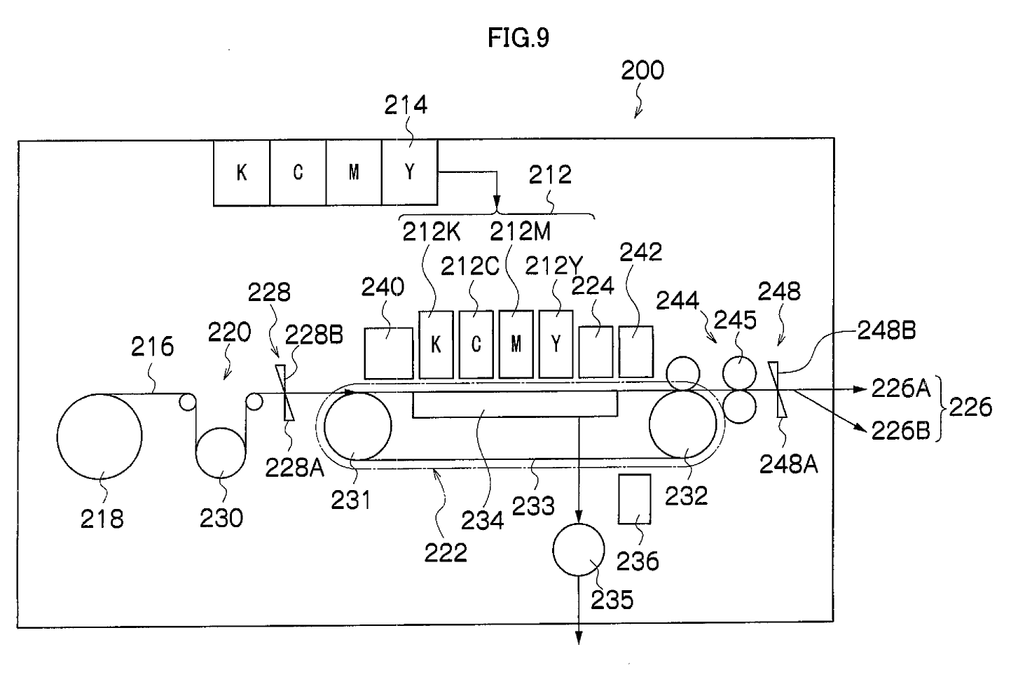

Next, a liquid ejection apparatus which is equipped with a cleaning apparatus relating to an embodiment of the present invention will be described as an application example of the first embodiment and the second embodiment described above. The liquid ejection apparatus shown in FIG. 9 is an inkjet recording apparatus 200 which can form desired color images by means of color inks ejected onto a recording medium. Firstly, the overall composition of the inkjet recording apparatus shown in FIG. 9 will be described.

As shown in FIG. 9, the inkjet recording apparatus 200 comprises: a printing unit 212 having a plurality of inkjet heads (hereinafter, called “heads”) 212K, 212C, 212M, and 212Y provided for ink colors of black (K), cyan (C), magenta (M), and yellow (Y), respectively; an ink storing and loading unit 214 for storing inks of K, C, M and Y to be supplied to the heads 212K, 212C, 212M, and 212Y; a paper supply unit 218 for supplying recording paper 216 which is a recording medium; a decurling unit 220 removing curl in the recording paper 216; a suction belt conveyance unit 222 disposed facing the ink-droplet ejection face of the head 212K, 212C, 212M, and 212Y, for conveying the recording paper 216 while keeping the recording paper 216 flat and a paper output unit 226 for outputting image-printed recording paper (printed matter) to the exterior.

The ink storing and loading unit 214 has ink supply tanks (not shown in FIG. 9; indicated by reference numeral 260 in FIG. 13) for storing the inks of K, C, M and Y to be supplied to the heads 212K, 212C, 212M, and 212Y, and the tanks of the respective colors are connected to the heads 212K, 212C, 212M, and 212Y by means of prescribed flow channels.

The ink storing and loading unit 214 has a warning device (for example, a display device or an alarm sound generator) for warning when the remaining amount of any ink is low, and has a mechanism for preventing loading errors among the colors. The details of the ink supply system including the ink storing and loading unit 214 shown in FIG. 9 are described below.

In FIG. 9, a magazine for rolled paper (continuous paper) is shown as an example of the paper supply unit 218; however, a plurality of magazines with paper differences such as paper width and quality may be jointly provided. Moreover, papers may be supplied with cassettes that contain cut papers loaded in layers and that are used jointly or in lieu of the magazine for rolled paper.

In the case of a configuration in which a plurality of types of recording paper can be used, it is preferable that an information recording medium such as a bar code and a wireless tag containing information about the type of paper is attached to the magazine, and by reading the information contained in the information recording medium with a predetermined reading device, the type of recording medium to be used (type of medium) is automatically determined, and ink-droplet ejection is controlled so that the ink-droplets are ejected in an appropriate manner in accordance with the type of medium.

The recording paper 216 delivered from the paper supply unit 218 retains curl due to having been loaded in the magazine. In order to remove the curl, heat is applied to the recording paper 216 in the decurling unit 220 by a heating drum 230 in the direction opposite from the curl direction in the magazine. The heating temperature at this stage is preferably controlled so that the recording paper 216 has a curl in which the surface on which the print is to be made is slightly round outward.

In the case of the configuration in which roll paper is used, a cutter (first cutter) 228 is provided as shown in FIG. 9, and the continuous paper is cut into a desired size by the cutter 228. The cutter 228 has a stationary blade 228A, whose length is not less than the width of the conveyor pathway of the recording paper 216, and a round blade 228B, which moves along the stationary blade 228A. The stationary blade 228A is disposed on the reverse side of the printed surface of the recording paper 216, and the round blade 228B is disposed on the printed surface side across the conveyor pathway. When cut papers are used, the cutter 228 is not required.

The decurled and cut recording paper 216 is delivered to the suction belt conveyance unit 222. The suction belt conveyance unit 222 has a configuration in which an endless belt 233 is set around rollers 231 and 232 so that the portion of the endless belt 233 facing at least the nozzle face of the printing unit 212 forms a horizontal plane (flat plane).

The belt 233 has a width that is greater than the width of the recording paper 216, and a plurality of suction apertures (not shown) are formed on the belt surface. A suction chamber 234 is disposed in a position facing the nozzle surface of the printing unit 212 on the interior side of the belt 233, which is set around the rollers 231 and 232, as shown in FIG. 9. The suction chamber 234 provides suction with a fan 235 to generate a negative pressure, and the recording paper 216 is held on the belt 233 by suction.

The belt 233 is driven in the clockwise direction in FIG. 9 by the motive force of a motor 288 (not shown in FIG. 9; indicated by reference numeral 288 in FIG. 14) being transmitted to at least one of the rollers 231 and 232, which the belt 233 is set around, and the recording paper 216 held on the belt 233 is conveyed from left to right in FIG. 9.

Since ink adheres to the belt 233 when a marginless print job or the like is performed, a belt-cleaning unit 236 is disposed in a predetermined position (a suitable position outside the printing area) on the exterior side of the belt 233. Although the details of the configuration of the belt-cleaning unit 236 are not shown, examples thereof include a configuration in which the belt 233 is nipped with cleaning rollers such as a brush roller and a water absorbent roller, an air blow configuration in which clean air is blown onto the belt 233, and a combination of these. In the case of the configuration in which the belt 233 is nipped with the cleaning rollers, it is preferable to make the line velocity of the cleaning rollers different from that of the belt 233 to improve the cleaning effect.

The inkjet recording apparatus 210 can comprise a roller nip conveyance mechanism, in which the recording paper 216 is pinched and conveyed with nip rollers, instead of the suction belt conveyance unit 222. However, there is a drawback in the roller nip conveyance mechanism that the image tends to be blurred when the printing area is conveyed by the roller nip action because the nip roller makes contact with the printed surface of the paper immediately after printing. Therefore, the suction belt conveyance in which nothing comes into contact with the image surface in the printing area is preferable.

A heating fan 240 is disposed on the upstream side of the printing unit 212 in the conveyance pathway formed by the suction belt conveyance unit 222. The heating fan 240 blows heated air onto the recording paper 216 to heat the recording paper 216 immediately before printing so that the ink deposited on the recording paper 216 dries more easily.

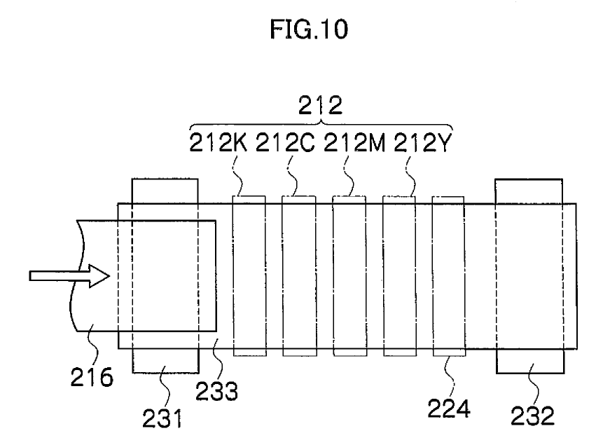

The heads 212K, 212C, 212M and 212Y of the printing unit 212 are full line heads having a length corresponding to the maximum width of the recording paper 216 used with the inkjet recording apparatus 200, and comprising a plurality of nozzles for ejecting ink arranged on a nozzle face through a length exceeding at least one edge of the maximum-size recording medium (namely, the full width of the printable range) (see FIG. 10).

The print heads 212K, 212C, 212M and 212Y are arranged in color order (black (K), cyan (C), magenta (M), yellow (Y)) from the upstream side in the feed direction of the recording paper 216, and these heads 212K, 212C, 212M and 212Y are fixed and arranged in the conveyance direction of the recording paper 216 (hereinafter, called the “paper conveyance direction”).

A color image can be formed on the recording paper 216 by ejecting inks of different colors from the heads 212K, 212C, 212M and 212Y, respectively, onto the recording paper 216 while the recording paper 216 is conveyed by the suction belt conveyance unit 222.

By adopting a configuration in which the full line heads 212K, 212C, 212M and 212Y having nozzle rows covering the full paper width are provided for the respective colors in this way, it is possible to record an image on the full surface of the recording paper 216 by performing just one operation of relatively moving the recording paper 216 and the printing unit 212 in the paper conveyance direction (the sub-scanning direction), in other words, by means of a single sub-scanning action. Higher-speed printing is thereby made possible and productivity can be improved in comparison with a shuttle type head configuration in which a recording head reciprocates in the main scanning direction.

Although the configuration with the KCMY four standard colors is described in the present embodiment, combinations of the ink colors and the number of colors are not limited. Light inks, dark inks or special color inks can be added as required. For example, a configuration is possible in which inkjet heads for ejecting light-colored inks such as light cyan and light magenta are added. Furthermore, there are no particular restrictions on the sequence in which the heads of respective colors are arranged. In an inkjet recording apparatus based on a two-liquid system in which treatment liquid and ink are deposited on the recording paper 216, and the ink coloring material is caused to aggregate or become insoluble on the recording paper 216, thereby separating the ink solvent and the ink coloring material on the recording paper 216, it is possible to provide an inkjet head as a device for depositing the treatment liquid onto the recording paper 216.

The print determination unit 224 has an image sensor for capturing an image of the ink-droplet deposition result of the printing unit 212, and functions as a device to check for ejection abnormalities such as clogs of the nozzles in the printing unit 212 from the ink-droplet deposition results evaluated by the image sensor.

The print determination unit 224 of the present embodiment is configured with at least a line sensor having rows of photoelectric transducing elements with a width that is greater than the ink-droplet ejection width (image recording width) of the heads 212K, 212C, 212M, and 212Y. This line sensor has a color separation line CCD sensor including a red (R) row of photoreceptor element composed of photoelectric transducing elements (pixels) arranged in a line provided with an R filter, a green (G) row of photoreceptor element with a G filter, and a blue (B) row of photoreceptor element with a B filter. Instead of a line sensor, it is possible to use an area sensor composed of photoelectric transducing elements which are arranged two-dimensionally.

The print determination unit 224 reads a test pattern printed by the print heads 212K, 212C, 212M, and 212Y of the respective colors, and determines the ejection performed by each heads 212K, 212C, 212M, and 212Y. The ejection determination includes detection of the ejection, measurement of the dot size, and measurement of the dot formation position.

A post-drying unit 242 is disposed following the print determination unit 224. The post-drying unit 242 is a device to dry the printed image surface, and includes a heating fan, for example. It is preferable to avoid contact with the printed surface until the printed ink dries, and a device that blows heated air onto the printed surface is preferable.

A heating/pressurizing unit 244 is disposed following the post-drying unit 242. The heating/pressurizing unit 244 is a device to control the glossiness of the image surface, and the image surface is pressed with a pair of pressure rollers 245 having a predetermined uneven surface shape while the image surface is heated, and the uneven shape is transferred to the image surface.

When the recording paper 216 is pressed by the heating/pressurizing unit 244, in cases in which printing is performed with dye-based ink on porous paper, blocking the pores of the paper by the application of pressure prevents the ink from coming contact with ozone and other substances that cause dye molecules to break down, and thereby has the effect of increasing the durability of the print.

The printed matter generated in this manner is outputted from the paper output unit 226. The target print (i.e., the result of printing the target image) and the test print are preferably outputted separately. In the inkjet recording apparatus 200, a sorting device (not shown) is provided for switching the outputting pathways in order to sort the printed matter with the target print and the printed matter with the test print, and to send them to paper output units 226A and 226B, respectively. When the target print and the test print are simultaneously formed in parallel on the same large sheet of paper, the test print portion is cut and separated by a cutter (second cutter) 248. The cutter 248 is disposed directly before the paper output unit 226, and is used for cutting the test print portion from the target print portion when a test print has been performed in the blank portion of the target print. The structure of the cutter 248 is the same as the first cutter 228 described above, and has a stationary blade 248A and a round blade 248B.

Although not shown in FIG. 9, the paper output unit 226A for the target prints is provided with a sorter for collecting prints according to print orders.

The inkjet recording apparatus 200 shown in FIG. 9 comprises a cleaning apparatus (not show in FIG. 9 and indicated by reference numeral 310 in FIG. 13) which carries out maintenance of the ink ejection surfaces of the heads 212K, 212C, 212M and 212Y. The cleaning apparatus may adopt the composition of a cleaning apparatus 10 relating to the first embodiment described above or it may adopt the composition of a cleaning apparatus 100 relating to the second embodiment.

### Structure of the Head

Next, the structure of a head will be described. The heads 212K, 212C, 212M and 212Y of the respective ink colors have the same structure, and a reference numeral 250 is hereinafter designated to any of the heads.

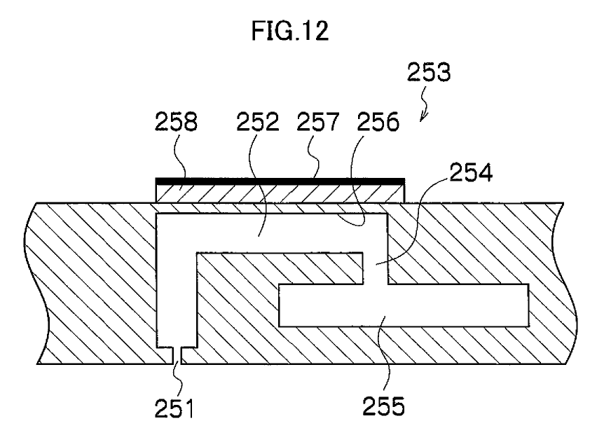

FIG. 11A is a perspective plan view showing an example of the configuration of the head 250, FIG. 11B is an enlarged view of a portion thereof, FIG. 11C is a perspective plan view showing another example of the configuration of the head 250, and FIG. 12 is a cross-sectional view taken along the line XII-XII in FIGS. 11A and 11B, showing the inner structure of a droplet ejection element (an ink chamber unit).

The nozzle pitch in the head 250 should be minimized in order to maximize the density of the dots printed on the surface of the recording paper 216. As shown in FIGS. 11A and 11B, the head 250 according to the present embodiment has a structure in which a plurality of ink chamber units 253, each comprising a nozzle 251 forming an ink droplet ejection hole, a pressure chamber 252 corresponding to the nozzle 251, and the like, are disposed two-dimensionally in the form of a staggered matrix, and hence the effective nozzle interval (the projected nozzle pitch) as projected in the lengthwise direction of the head (the sub-scanning direction perpendicular to the paper conveyance direction) is reduced and high nozzle density is achieved.

The mode of forming one or more nozzle rows through a length corresponding to the entire width of the recording paper 216 in a direction substantially perpendicular to the conveyance direction of the recording paper 216 is not limited to the example described above. For example, instead of the configuration in FIG. 11A, as shown in FIG. 11C, a line head having nozzle rows of a length corresponding to the entire width of the recording paper 216 can be formed by arranging and combining, in a staggered matrix, short head blocks 250′ having a plurality of nozzles 251 arrayed in a two-dimensional fashion. Furthermore, although not shown in the drawings, it is also possible to compose a line head by arranging short heads in one row.

The planar shape of the pressure chamber 252 provided for each nozzle 251 is substantially a square, and the nozzle 251 and an ink supply port 254 are disposed in both corners on a diagonal line of the square. Each pressure chamber 252 is connected to a common flow passage 255 through the supply port 254. The common flow passage 255 is connected to an ink supply tank (not shown in FIGS. 11A to 11C; indicated by reference numeral 260 in FIG. 13), which is a base tank that supplies ink, and the ink supplied from the ink supply tank is delivered through the common flow passage 255 in FIG. 12 to the pressure chambers 252.

A piezoelectric element 258 provided with an individual electrode 257 is joined to a diaphragm 256 which forms the upper face of the pressure chamber 252 and which is used also as a common electrode, and the piezoelectric element 258 is deformed when a drive voltage is supplied to the individual electrode 257, thereby causing ink to be ejected from the nozzle 251. When ink is ejected, new ink is supplied to the pressure chamber 252 from the common flow passage 255, via the supply port 254.

In the present example, a piezoelectric element 258 is used as an ink ejection force generating device which causes ink to be ejected from a nozzle 251 provided in the head 250, but it is also possible to employ a thermal method in which a heater is provided inside the pressure chamber 252 and ink is ejected by using the pressure of the film boiling action caused by the heating action of this heater.

As shown in FIG. 11B, a high-density nozzle head according to the present embodiment is achieved by arranging a plurality of ink chamber units 253 having the above-described structure in a lattice fashion based on a fixed arrangement pattern, in a row direction which coincides with the main scanning direction, and a column direction which is inclined at a fixed angle of θ with respect to the main scanning direction, rather than being perpendicular to the main scanning direction.

More specifically, by adopting a structure in which a plurality of ink chamber units 253 are arranged at a uniform pitch d in line with a direction forming an angle of θ with respect to the main scanning direction, the pitch P of the nozzles projected so as to align in the main scanning direction is d×cos θ, and hence the nozzles 251 can be regarded to be equivalent to those arranged linearly at a fixed pitch P along the main scanning direction. Such configuration results in a nozzle structure in which the nozzle row projected in the main scanning direction has a high nozzle density of up to 2,400 nozzles per inch.

When implementing the present invention, the arrangement structure of the nozzles is not limited to the example shown in the drawings, and it is also possible to apply various other types of nozzle arrangements, such as an arrangement structure having one nozzle row in the sub-scanning direction.

Furthermore, the scope of application of the present invention is not limited to a printing system based on a line type of head, and it is also possible to adopt a serial system where a short head which is shorter than the breadthways dimension of the recording paper 216 is moved (scanned) in the breadthways direction of the recording paper 216, thereby performing printing in the breadthways direction, and when one printing action in the breadthways direction has been completed, the recording paper 216 is moved through a prescribed amount in the direction perpendicular to the breadthways direction, printing in the breadthways direction of the recording paper 216 is carried out in the next printing region, and by repeating this sequence, printing is performed over the whole surface of the printing region of the recording paper 216.

### Configuration of an Ink Supply System

FIG. 13 is a schematic drawing showing the configuration of the ink supply system in the inkjet recording apparatus 200. The ink supply tank 260 is a base tank that supplies ink to the head 250 and is set in the ink storing and loading unit 214 described with reference to FIG. 9. The aspects of the ink supply tank 260 include a refillable type and a cartridge type: when the remaining amount of ink is low, the ink tank of the refillable type is filled with ink through a filling port (not shown) and the ink tank of the cartridge type is replaced with a new one. In order to change the ink type in accordance with the intended application, the cartridge type is suitable, and it is preferable to represent the ink type information with a bar code or the like on the cartridge, and to perform ejection control in accordance with the ink type.

A filter 262 for removing foreign matters and bubbles is disposed between the ink supply tank 260 and the head 250 as shown in FIG. 13. The filter mesh size in the filter 62 is preferably equivalent to or less than the diameter of the nozzle and commonly about 20 μm.

Although not shown in FIG. 13, it is preferable to provide a sub-tank integrally to the print head 250 or near the head 250. The sub-tank has a damper function for preventing variation in the internal pressure of the head and a function for improving refilling of the print head.

The inkjet recording apparatus 200 is also provided with a cap 264 as a device to prevent the nozzles 251 from drying out or to prevent an increase in the ink viscosity in the vicinity of the nozzles 251, and a cleaning apparatus 310 as a device to clean the nozzle face.

A maintenance unit including the cap 264 and the cleaning apparatus 310 can be moved relative to the head 250 by a movement mechanism (not shown), and is moved from a predetermined holding position to a maintenance position below the head 250 as required.

The cap 264 is displaced up and down relatively with respect to the head 250 by an elevator mechanism (not shown). When the power of the inkjet recording apparatus 200 is turned OFF or when in a print standby state, the cap 264 is raised to a predetermined elevated position so as to come into close contact with the head 250, and the nozzle face is thereby covered with the cap 264.

During printing or standby, if the use frequency of a particular nozzle 251 is low, and if a state of not ejecting ink continues for a prescribed time period or more, then the solvent of the ink in the vicinity of the nozzle evaporates and the viscosity of the ink increases. In a situation of this kind, it will become impossible to eject ink from the nozzle 251, even if the piezoelectric element 258 is operated.

Therefore, before a situation of this kind develops (namely, while the ink is within a range of viscosity which allows it to be ejected by operation of the piezoelectric element 258), the piezoelectric element 258 is operated, and a preliminary ejection (“purge”, “blank ejection”, “liquid ejection” or “dummy ejection”) is carried out toward the cap 264 (ink receptacle), in order to expel the degraded ink (namely, the ink in the vicinity of the nozzle which has increased viscosity).

Furthermore, if air bubbles enter into the ink inside the head 250 (inside the pressure chamber 252), then even if the piezoelectric element 258 is operated, it will not be possible to eject ink from the nozzle properly. In a case of this kind, the cap 264 is placed on the head 250, the ink (ink containing air bubbles) inside the pressure chamber 252 is removed by suction, by means of a suction pump 265, and the ink removed by suction is then supplied to a recovery tank 268.

When ink is initially loaded into the head, or when service has started after a long period of being stopped, for instance, degraded ink whose viscosity has increased (hardened ink) is subject to suctioning by this suction action. Since this suction action is performed with respect to all the ink in the pressure chambers 252, the amount of ink consumption is considerable. Therefore, a preferred aspect is one in which a preliminary discharge is performed when the increase in the viscosity of the ink is small.

The inkjet recording apparatus 200 shown in the present embodiment comprises the cleaning apparatus 310 for removing adhering material which is attached to the ink ejection surface 250A of the head 250. The cleaning apparatus 310 shown in FIG. 13 is composed so as to be movable between a maintenance position directly below the head 250 and a withdrawn position which is distanced from the head 250, by means of a movement mechanism (not illustrated). FIG. 13 shows a state where the cleaning apparatus 310 is positioned at the maintenance position directly below the head 250.

The cleaning apparatus 310 has a similar composition to the cleaning apparatus 100 shown in FIG. 6, and comprises: a fine liquid particle generating apparatus 321 having a fine liquid particle outlet port 314 from which fine liquid particles are sprayed onto the ink ejection surface 250A, and a liquid storage chamber 320 which stores liquid to be formed into fine liquid particles to be sprayed from the fine liquid particle outlet port 314; a cleaning blade 318; and an adhering material determination sensor 302 which determines adhering material on the ink ejection surface 12A.

The adhering material determination sensor 302 and the fine liquid particle generating apparatus 321 are mounted on a carriage 322, and the carriage 322 is supported on guide rails 324 so as to be movable reciprocally directly below the head 250 in the lengthwise direction of the head 250 (the main scanning direction indicated by the arrow in FIG. 13), within a plane that is parallel to the ink ejection surface 250A. Although not shown in FIG. 13, the adhering material determination sensor 302 is composed so as to be movable reciprocally in the vertical direction, by means of an elevator mechanism (not illustrated).

The cleaning blade 318 is mounted on a carriage 326 which is supported on the guide rails 324, and the carriage 326 is composed so as to be movable reciprocally directly below the head 250 in the lengthwise direction of the head 250 (the main scanning direction indicated by the arrow in FIG. 13), within a plane that is parallel to the ink ejection surface 250A. Furthermore, in order to switch between a state where the cleaning blade 318 is made to contact (abut against) the ink ejection surface 250A, and a state where the cleaning blade 318 is separated from the ink ejection surface 250A, a movement mechanism 327 is provided in order to move the cleaning blade 318 in the vertical direction (the ink ejection direction of the head 250 indicated by arrow Z in FIG. 13). An elastic member such as rubber is suitably used for the cleaning blade 318. When the soiling on the ink ejection surface 250A is cleaned away by the clearing apparatus 310, a preliminary ejection is also carried out in order to prevent the foreign matter from becoming mixed inside the nozzle 251 by the cleaning blade 318.

### Description of Control System

FIG. 14 is a principal block diagram showing the system configuration of the inkjet recording apparatus 200. The inkjet recording apparatus 200 comprises a communications interface 270, a system controller 272, a memory 274, a motor driver 276, a heater driver 278, a print controller 280, an image buffer memory 282, a head driver 284, and the like.

The communications interface 270 is an interface unit for receiving image data sent from a host computer 286. A serial interface such as USB (Universal Serial Bus), IEEE1394, Ethernet (registered trademark), wireless network, or a parallel interface such as a Centronics interface may be used as the communications interface 270. A buffer memory (not shown) may be mounted in this portion in order to increase the communication speed. The image data sent from the host computer 286 is received by the inkjet recording apparatus 200 through the communications interface 270, and is temporarily stored in the memory 274.

The memory 274 is a storage device for temporarily storing images inputted through the communications interface 270, and data is written and read to and from the image memory 274 through the system controller 272. The memory 274 is not limited to a memory composed of semiconductor elements, and a hard disk drive or another magnetic medium may be used.

The system controller 272 is constituted by a central processing unit (CPU) and peripheral circuits thereof, and the like, and it functions as a control device for controlling the whole of the inkjet recording apparatus 200 in accordance with prescribed programs, as well as a calculation device for performing various calculations. More specifically, the system controller 272 controls the various sections, such as the communications interface 270, memory 274, motor driver 276, heater driver 278, and the like, so as to control communications with the host computer 286, writing and reading to and from the memory 274, and also generation of control signals for controlling the heater 289 and the motor 288 of the conveyance system.

The programs executed by the CPU of the system controller 272 and the various types of data which are required for control procedures are stored in the memory 274. The memory 274 may be a non-writeable storage device, or it may be a rewriteable storage device, such as an EEPROM. The memory 274 is used as a temporary storage region for the image data, and it is also used as a program development region and a calculation work region for the CPU.

The motor driver 276 drives the motor 288 in accordance with commands from the system controller 272. In FIG. 14, the motors (actuators) disposed in the respective sections of the apparatus are represented by the reference numeral 288. For example, the motor 288 shown in FIG. 14 includes a motor which drives the rollers 231, 232 in FIG. 9, a motor of the movement mechanism which moves the cap 264 in FIG. 13, a motor of the movement mechanism which moves the carriage 322 and the carriage 326 in FIG. 13, and the like.

The heater driver 278 drives the heater 289 including a heater serving as a heat source of the heating fan 240 shown in FIG. 9 and a heater of the post-drying unit 242, in accordance with commands from the system controller 272.

The print controller 280 has a signal processing function for performing various tasks, compensations, and other types of processing for generating print control signals from the image data stored in the memory 274 in accordance with commands from the system controller 272 so as to supply the generated print data (dot data) to the head driver 284. Prescribed signal processing is carried out in the print controller 280, and the ejection amount and the ejection timing of the ink droplets from the respective print heads 250 are controlled via the head driver 284, on the basis of the print data. By this means, desired dot size and dot positions can be achieved.

The print controller 280 is provided with the image buffer memory 282; and image data, parameters, and other data are temporarily stored in the image buffer memory 282 when image data is processed in the print controller 280. Also possible is an aspect in which the print controller 280 and the system controller 272 are integrated to form a single processor.

The head driver 284 generates drive signals to be applied to the piezoelectric elements 258 of the head 250, on the basis of image data supplied from the print controller 280, and also comprises drive circuits which drive the piezoelectric elements 258 by applying the drive signals to the piezoelectric elements 258. The head driver 284 shown in FIG. 14 can be provided with a feedback control system for maintaining constant drive conditions for the head 250.

The print determination unit 224 is a block that includes the line sensor as described above with reference to FIG. 9, reads the image printed on the recording paper 216, determines the print conditions (presence of the ejection, variation in the dot formation, and the like) by performing required signal processing, or the like, and provides the determination results of the print conditions to the print controller 280.

According to requirements, the print controller 280 makes various corrections with respect to the head 250 or carries out the maintenance of the head 250 on the basis of information obtained from the print determination unit 224.

The image data to be printed is externally inputted through the communications interface 270, and is stored in the memory 274. In this stage, the RGB image data is stored in the image memory 274.

The data stored in the memory 274 is sent to the print controller 280 through the system controller 272, and is converted to the dot data for each ink color, in the print controller 280. In other words, the print controller 280 performs processing for converting the inputted RGB image data into dot data for four colors, K, C, M and Y. The dot data generated by the print controller 280 is stored in the image buffer memory 282.

Various control programs are stored in a program storage section 290, and a control program is read out and executed in accordance with commands from the system controller 272. The program storage section 290 may use a semiconductor memory, such as a ROM, EEPROM, or a magnetic disk, or the like. An external interface may be provided, and a memory card or PC card may also be used. Naturally, a plurality of these storage media may also be provided. The program storage section 290 also serves as a storage medium for operation parameters.

The system controller 272 acquires information on the elapsed time from the timer 382 which counts the elapsed time from the start of the generation of the fine liquid particles by the cleaning apparatus 310, and it writes this value occasionally to a prescribed region of the memory 274. The movement of the carriage 326 on which the cleaning blade 318 is mounted is controlled on the basis of this timer value.

Furthermore, the system controller 272 controls the opening and closing the valve 333 provided in the liquid supply port in the fine liquid particle generating apparatus 321 (see FIG. 13), via a valve driver 283. In other words, if the level of the liquid inside the liquid storage chamber 320 is less than a prescribed value, on the basis of the determination result of the level sensor 346 provided in the liquid storage chamber 320, then the valve 333 is opened in such a manner that liquid is supplied to the liquid storage chamber 320, and when the replenishment of a prescribed amount of liquid has been completed, the valve 333 is controlled so as to close the valve 333.

The system controller 272 judges the presence or absence of adhering material, and the position and thickness (magnitude) of the adhering material, on the basis of the information relating to the adhering material obtained from the adhering material determination sensor 302 (for example, image information for the adhering material), and controls the driving of the piezoelectric element 342 of the fine liquid particle generating apparatus 321 via the piezoelectric element drive unit 378. The piezoelectric element drive unit 378 shown in FIG. 14 comprises an AC power source unit which generates a high-frequency AC voltage, a control unit which controls the frequency and the amplitude (voltage) of the AC voltage output from the AC power source unit, and a drive circuit for applying the high-frequency AC voltage to the piezoelectric element 342.

Furthermore, the system controller 272 judges the position of the carriage 322 at the time that adhering material is determined (in other words, judges the position of the adhering material), from the pulse signal output from the encoder 304 which is attached to the drive motor of the carriage 322, and stores the positional information for the adhering material, and the information on the adhering material obtained from the adhering material determination sensor 302, as a set, in a prescribed region of the memory 274.

In other words, the system controller 272 stores information indicating positions (areas) of the ink ejection surface 250A where adhering materials are present (see FIG. 13), and alters the amount of fine liquid particles deposited on the corresponding areas.

In the present application example, an inkjet recording apparatus which forms a color image on a recording medium is described as one example of a liquid ejection apparatus to which a cleaning apparatus relating to an embodiment of the present invention can be applied, but the present invention can also be applied broadly to other liquid ejection apparatuses, such as a dispenser.

It should be understood that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A cleaning apparatus which cleans a liquid ejection surface of a liquid ejection head, the cleaning apparatus comprising:
a liquid storage chamber which stores a first liquid;
a vibrating device which converts the first liquid stored in the liquid storage chamber into fine particles of the first liquid;
a fine liquid particle outlet port from which the fine particles of the first liquid is sprayed toward the liquid ejection surface; and
a wiping device which wipes the liquid ejection surface after the fine particles of the first liquid sprayed from the fine liquid particle outlet port are deposited on the liquid ejection surface.

2. The cleaning apparatus as defined in claim 1, wherein the fine particles of the first liquid are sprayed from the fine liquid particle outlet port only by a vibration pressure caused by the vibrating device.

3. The cleaning apparatus as defined in claim 1, wherein the wiping device wipes the liquid ejection surface after a prescribed period of time has elapsed from when the fine particles of the first liquid are sprayed toward the liquid ejection surface.

4. The cleaning apparatus as defined in claim 1, further comprising a movement device which causes a relative movement between the liquid ejection surface and the fine liquid particle outlet port disposed so as to oppose the liquid ejection surface, over the whole liquid ejection surface.

5. The cleaning apparatus as defined in claim 1, wherein the vibrating device comprises a piezoelectric element.

6. The cleaning apparatus as defined in claim 1, wherein the first liquid is water.

7. The cleaning apparatus as defined in claim 1, further comprising:
a determination device which determines presence or absence of adhering material on the liquid ejection surface and a position of the adhering material on the liquid ejection surface; and
a vibration control device which controls the vibrating device in such a manner that an amount of the fine particles of the first liquid to be deposited on the liquid ejection surface is made greater at a position where the presence of the adhering material has been determined by the determination device, than at a position where the presence of the adhering material has not been determined by the determination device.

8. The cleaning apparatus as defined in claim 1, further comprising:
a determination device which determines presence or absence of adhering material and a position of the adhering material with respect to each of regions into which the liquid ejection surface divided;
a vibration control device which controls the vibrating device in such a manner that an amount of the fine particles of the first liquid to be deposited on the liquid ejection surface is made greater in the region where the presence of the adhering material has been determined by the determination device, than in the region where the presence of the adhering material has not been determined by the determination device.

9. The cleaning apparatus as defined in claim 7, wherein:
the determination device determines a thickness of the adhering material; and
the vibration control device controls the vibrating device in such a manner that the amount of the fine particles of the first liquid to be deposited on the liquid ejection surface is increased, as the thickness of the adhering material determined by the determination device increases.

10. The cleaning apparatus as defined in claim 8, wherein:
the determination device determines a thickness of the adhering material; and
the vibration control device controls the vibrating device in such a manner that the amount of the fine particles of the first liquid to be deposited on the liquid ejection surface is increased, as the thickness of the adhering material determined by the determination device increases.

11. The cleaning apparatus as defined in claim 9, wherein the vibration control device controls the vibrating device in such a manner that the fine particles of the first liquid are deposited on the liquid ejection surface so that an average thickness of the first liquid on the liquid ejection surface is two times the thickness of the adhering material.

12. The cleaning apparatus as defined in claim 10, wherein the vibration control device controls the vibrating device in such a manner that the fine particles of the first liquid are deposited on the liquid ejection surface so that an average thickness of the first liquid on the liquid ejection surface is two times the thickness of the adhering material.

13. A liquid ejection apparatus comprising:
a liquid ejection head which ejects a second liquid onto an ejection receiving medium; and
the cleaning apparatus as defined in claim 1.

14. A liquid ejection surface cleaning method of cleaning a liquid ejection surface of a liquid ejection head, the liquid ejection surface cleaning method comprising the steps of:
vibrate a first liquid so that fine particles of the first liquid are sprayed onto the liquid ejection surface; and
wiping the liquid ejection surface after spraying the fine particles of the first liquid onto the liquid ejection surface.
